(19) United States
(12) Patent Application Publication
(10) Pub. No.: US 2013/0297459 A1
(43) Pub. Date: Nov. 7, 2013

(54) ELECTRONIC CATALOG SYSTEM AND METHOD

(71) Applicants: DANIEL KISER, Roanoke, VA (US); Richard Kempski, Chagrin Falls, OH (US)

(72) Inventors: DANIEL KISER, Roanoke, VA (US); Richard Kempski, Chagrin Falls, OH (US)

(21) Appl. No.: 13/746,617

(22) Filed: Jan. 22, 2013

Related U.S. Application Data
(60) Provisional application No. 61/588,284, filed on Jan. 19, 2012.

(51) Int. Cl. G06Q 30/06

(52) U.S. Cl. CPC G06Q 30/0603
USPC 705/27.1

(57) ABSTRACT

An electronic catalog system for identifying a component includes computer memory storage upon which is stored software and a database containing data for a number of types of the component. The data includes images, diagrams, dimensions and specifications for each of the types of the component. The system also includes a workstation and a server computer in communication with the computer memory storage and the workstation. The server computer executes the software so that images of the different types of the component are displayed on the workstation to a user. The user may select one of the plurality of types of the component. A number of alternative diagrams for the selected type of component are displayed and the user may select one. A dimension is illustrated on the selected diagram, and the user enters this dimension. A component matching the selected type, the selected diagram and the entered dimension is then displayed.

### CLAIM OF PRIORITY

This application claims priority to U.S. Provisional Patent Application No. 61/588,284, filed Jan. 19, 2012, the contents of which are hereby incorporated by reference.

### FIELD OF THE INVENTION

The present invention relates generally to electronic catalogs accessible by computer and, more particularly, to an electronic catalog whereby components may be searched for and identified using visual images in combination with component specifications.

### BRIEF DESCRIPTION OF THE DRAWINGS

FIG. 1 is a schematic illustrating an embodiment of the system of the invention;

FIG. 2 illustrates an initial data entry screen in an embodiment of the system and method of the invention;

FIG. 3 is a flow chart illustrating the steps and processing performed for identifying an air spring component in accordance with an embodiment of the system and method of the invention;

FIG. 4A illustrates a data entry and display screen for selecting a top plate diameter of a Rolling Lobe type air spring in an embodiment of the system and method of the invention;

FIG. 4B illustrates a data entry and display screen for selecting a top plate diagram of a Rolling Lobe type air spring in an embodiment of the system and method of the invention;

FIG. 4C illustrates a data entry and display screen for selecting a length of dimension “A” of a Rolling Lobe type air spring in an embodiment of the system and method of the invention;

FIG. 4D illustrates a data entry and display screen for selecting images of a Rolling Lobe type air spring in an embodiment of the system and method of the invention;

FIG. 4E illustrates a display screen for illustrating specifications of a Rolling Lobe type air spring in an embodiment of the system and method of the invention;

FIG. 4F illustrates a data entry and display screen corresponding to the screen of FIG. 2C when a different top plate diameter is selected using the screen of FIG. 4A and a different top plate diagram is selected using the screen of FIG. 2B;

FIG. 4G illustrates a data entry and display screen for selecting images of a Rolling Lobe type air spring after the screen of FIG. 4F is used;

FIG. 5A illustrates a data entry and display screen for selecting a top plate diameter for a Single Convoluted type air spring in an embodiment of the system and method of the invention;

FIG. 5B illustrates a data entry and display screen for selecting a top plate diagram for a Single Convoluted type air spring in an embodiment of the system and method of the invention;

FIG. 5C illustrates a data entry and display screen for selecting a length of dimension “A” of a Single Convoluted type air spring in an embodiment of the system and method of the invention;

FIG. 6A illustrates a data entry and display screen for selecting a top plate diameter for a Double Convoluted type air spring in an embodiment of the system and method of the invention;

FIG. 6B illustrates a data entry and display screen for selecting a top plate diagram for a Double Convoluted type air spring in an embodiment of the system and method of the invention;

FIG. 6C illustrates a data entry and display screen for selecting a length of dimension “A” of a Double Convoluted type air spring in an embodiment of the system and method of the invention;

FIG. 6D illustrates a data entry and display screen for selecting a number of studs in a Double Convoluted type air spring in an embodiment of the system and method of the invention;

FIG. 6E illustrates a display screen listing Double Convoluted type air springs after the screen of FIG. 6D is used;

FIG. 7A illustrates a data entry and display screen for selecting a top plate diameter of a Triple Convoluted type air spring in an embodiment of the system and method of the invention;

FIG. 7B illustrates a data entry and display screen for selecting a top plate diagram of a Triple Convoluted type air spring in an embodiment of the system and method of the invention;

FIG. 7C illustrates a data entry and display screen for selecting a length of dimension “A” of a Triple Convoluted type air spring in an embodiment of the system and method of the invention;

FIG. 7D illustrates a data entry and display screen for selecting an air inlet size of a Triple Convoluted type air spring in an embodiment of the system and method of the invention;

FIG. 7E illustrates a display screen listing Triple Convoluted type air springs;

FIG. 8A illustrates a data entry and display screen for selecting a top plate diameter of a Cab Bag type air spring in an embodiment of the system and method of the invention;

FIG. 8B illustrates a display screen listing Cab Bag type air springs after the screen of FIG. 8A is used;

FIG. 9 is a flow chart illustrating the steps and processing performed for identifying a suspension component in accordance with an embodiment of the system and method of the invention;

FIG. 10A illustrates a data entry and display screen for selecting a Tie Rod type in an embodiment of the system and method of the invention;

FIG. 10B illustrates a data entry and display screen for selecting a Tie Rod stud center to rod end size in an embodiment of the system and method of the invention;

FIG. 10C illustrates a data entry and display screen for selecting a Tie Rod rod thread size in an embodiment of the system and method of the invention;

FIG. 10D illustrates a data entry and display screen for selecting a Tie Rod large diameter size in an embodiment of the system and method of the invention;

FIG. 10E illustrates a data entry and display screen for selecting a Tie Rod small diameter size in an embodiment of the system and method of the invention;

FIG. 10F illustrates a data entry and display screen for selecting a Tie Rod stud thread size in an embodiment of the system and method of the invention;

FIG. 10G illustrates a data entry and display screen for selecting a Tie Rod taper length in an embodiment of the system and method of the invention;

FIG. 10H illustrates a display screen showing an illustration and dimensions for a Tie Rod;

FIG. 11A illustrates a data entry and display screen for selecting a type of Torque Rod in an embodiment of the system and method of the invention;

FIG. 11B illustrates a data entry and display screen for selecting a manufacturer of a Torque Rod in an embodiment of the system and method of the invention;

FIG. 11C illustrates a data entry and display screen for selecting a between a rigid and adjustable Torque Rod in an embodiment of the system and method of the invention;

FIG. 11D illustrates a data entry and display screen for selecting a bushing type for a Torque Rod in an embodiment of the system and method of the invention;

FIG. 11E illustrates a data entry and display screen for selecting a hole diameter for a Torque Rod in an embodiment of the system and method of the invention;

FIG. 11F illustrates a data entry and display screen for selecting a length of a Torque Rod in an embodiment of the system and method of the invention;

FIG. 11G illustrates a display screen listing a Torque Rod;

FIG. 12A-12B illustrates a data entry and display screen for selecting a King Pin type in an embodiment of the system and method of the invention;

FIG. 12C illustrates a data entry and display screen for selecting a King Pin diameter in an embodiment of the system and method of the invention;

FIG. 12D illustrates a data entry and display screen for selecting a King Pin length in an embodiment of the system and method of the invention;

FIG. 12E illustrates a display screen listing King Pins;

FIG. 13A-13C illustrates a data entry and display screen for selecting a U-bolt type in an embodiment of the system and method of the invention;

FIG. 13D illustrates a data entry and display screen for selecting a U-bolt thread size in an embodiment of the system and method of the invention;

FIG. 13E illustrates a data entry and display screen for selecting a U-bolt width in an embodiment of the system and method of the invention;

FIG. 13F illustrates a data entry and display screen for selecting a U-bolt length in an embodiment of the system and method of the invention;

FIG. 13G illustrates a display screen for showing a U-bolt in an embodiment of the system and method of the invention;

FIG. 14A illustrates a first data entry and display screen for selecting a Spring Pin type in an embodiment of the system and method of the invention;

FIG. 14B illustrates a second data entry and display screen for selecting a Spring Pin type in an embodiment of the system and method of the invention;

FIG. 14C illustrates a third data entry and display screen for selecting a Spring Pin type in an embodiment of the system and method of the invention;

FIG. 14D illustrates a fourth data entry and display screen for selecting a Spring Pin type in an embodiment of the system and method of the invention;

FIG. 14E illustrates a data entry and display screen for selecting a Spring Pin manufacturer in an embodiment of the system and method of the invention;

FIG. 14F illustrates a data entry and display screen for selecting a Spring Pin diameter in an embodiment of the system and method of the invention;

FIG. 14G illustrates a display screen for listing a Spring Pin;

FIG. 15A illustrates a data entry and display screen for selecting Tie Rod by Axle Code in an embodiment of the system and method of the invention;

FIG. 15B illustrates a display screen listing a Tie Rod after the screen of FIG. 15A is used;

FIG. 16A illustrates a data entry and display screen for selecting King Pin by Axle Code in an embodiment of the system and method of the invention;

FIG. 16B illustrates a display screen listing a King Pin after the screen of FIG. 16A is used.

### DETAILED DESCRIPTION OF EMBODIMENTS

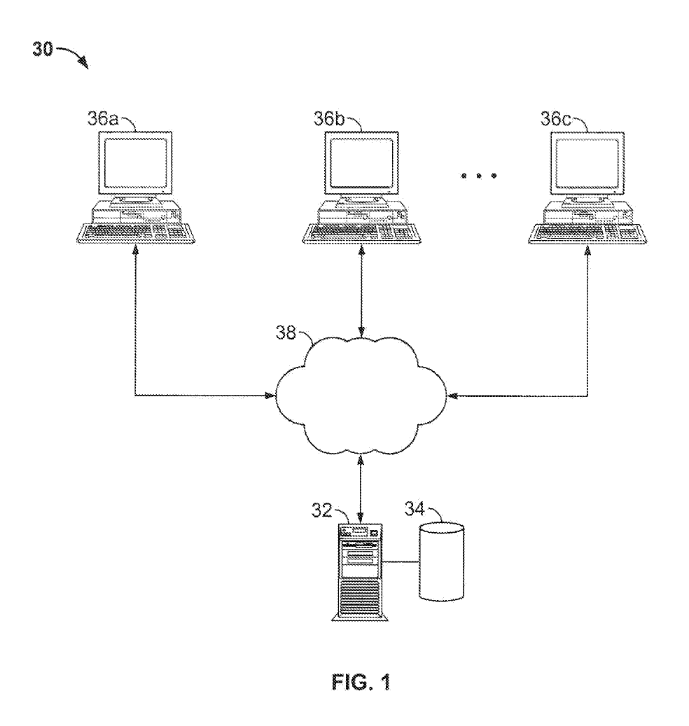

An embodiment of the electronic catalog system of the present invention is indicated in general at 30 in FIG. 1. The system includes a server computer 32 that is loaded with and configured to run software that accomplishes the functionality described below. The server communicates with computer memory storage device 34 upon which is stored a database containing data regarding air spring and suspension components. This data includes image data, dimensions and specifications which will be describe in greater detail below. The server computer 32 may be accessed by users via workstations 36a-36c which communicate with server 32 through a network 38 which may be, for example, the Internet. Workstations 36a-36c may be computers or other types of display devices known in the art. As an alternative to the network arrangement illustrate in FIG. 1, the software may be loaded on a standalone computer.

While the invention is described below in terms of air spring and other suspension components, it is to be understood that the system and method of the invention may be used to electronically catalog and access other types of components, products or other items. In addition, it should be understood that the specific screen layouts and flow charts are presented as examples only and are intended in no way to limit the invention.

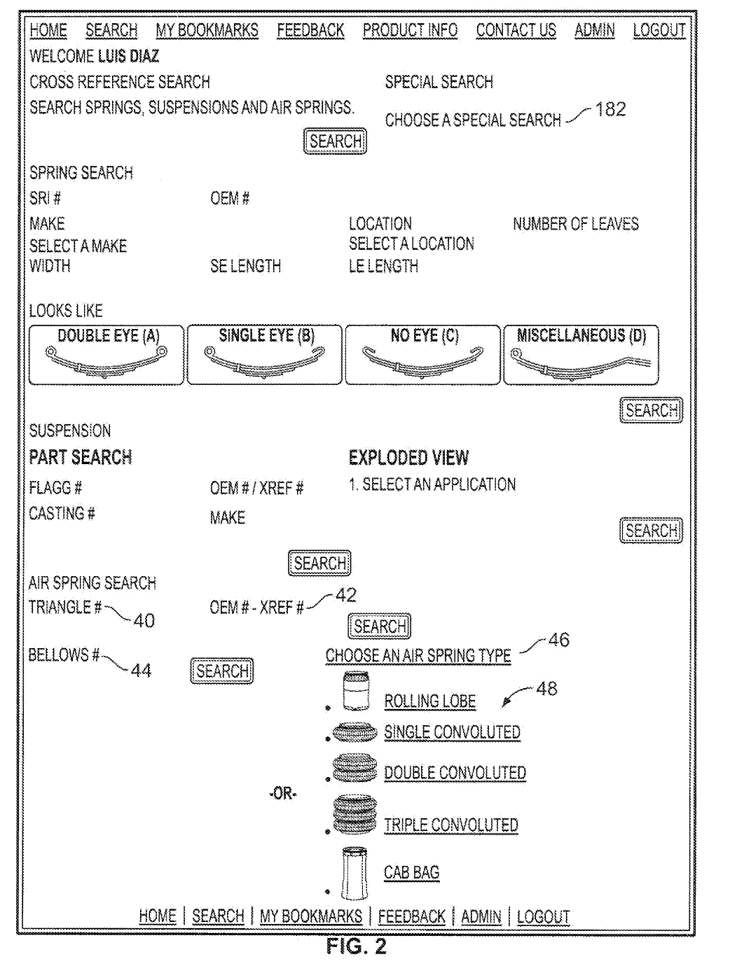

The initial data entry screen displayed to a user accessing the system (such as by workstation 36a of FIG. 1) is presented in FIG. 2. To search for data for a specific air spring, the user may enter manufacturer part or cross-reference numbers in either field 40 or 42. If the user does not know this information, but does know the bellows number for the air spring, this number may be entered in field 44. If the user does not know this information, he or she may select the air spring type by clicking on the “Choose an Air Spring Type” icon, indicated at 46. When the user takes this action, a list of air spring types is displayed via a drop down menu, indicated in general at 48 in FIG. 2. As illustrated at 48, an illustration of the air spring type is provided by the side of each air spring type listed in the drop down menu.

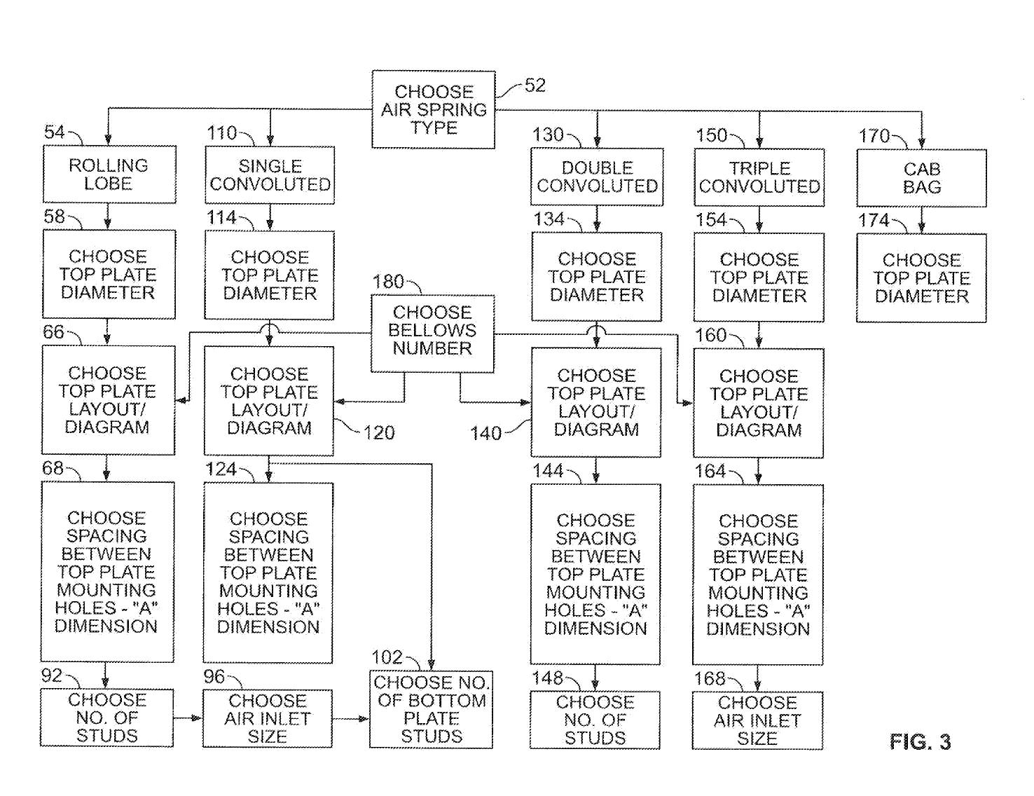

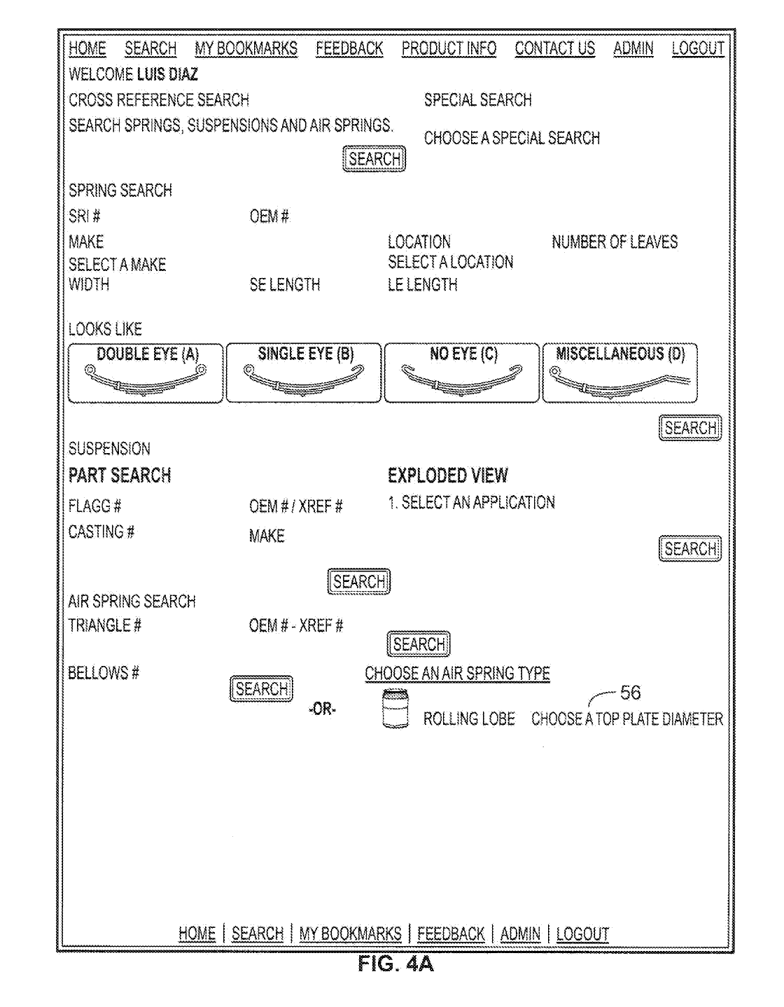

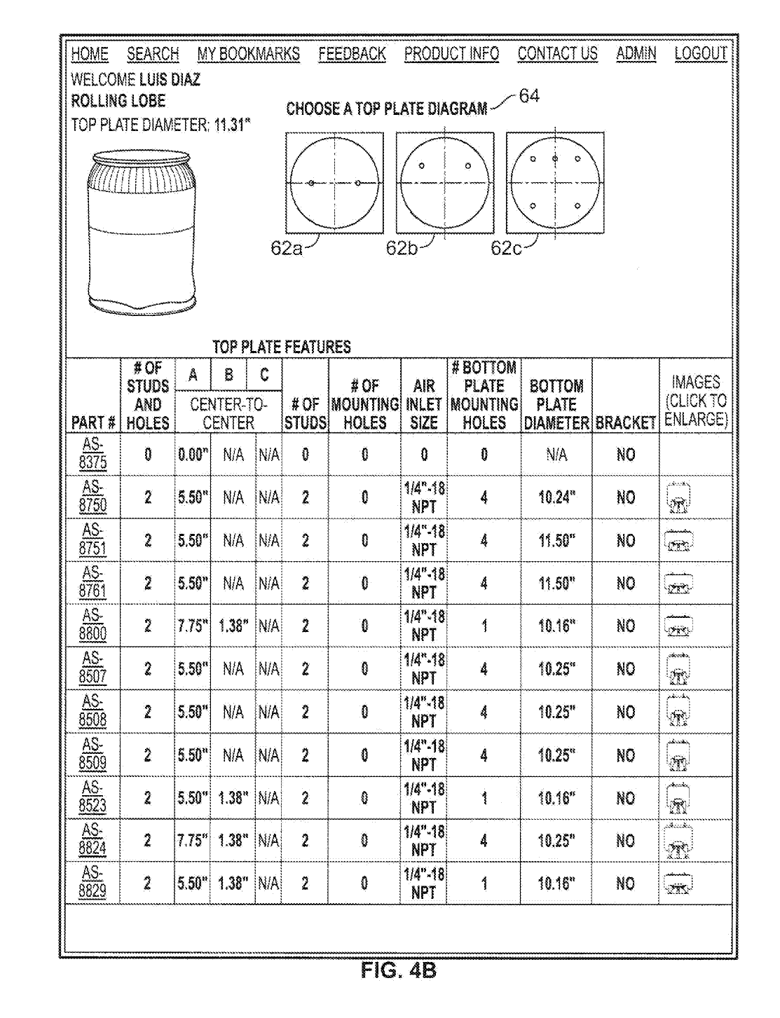

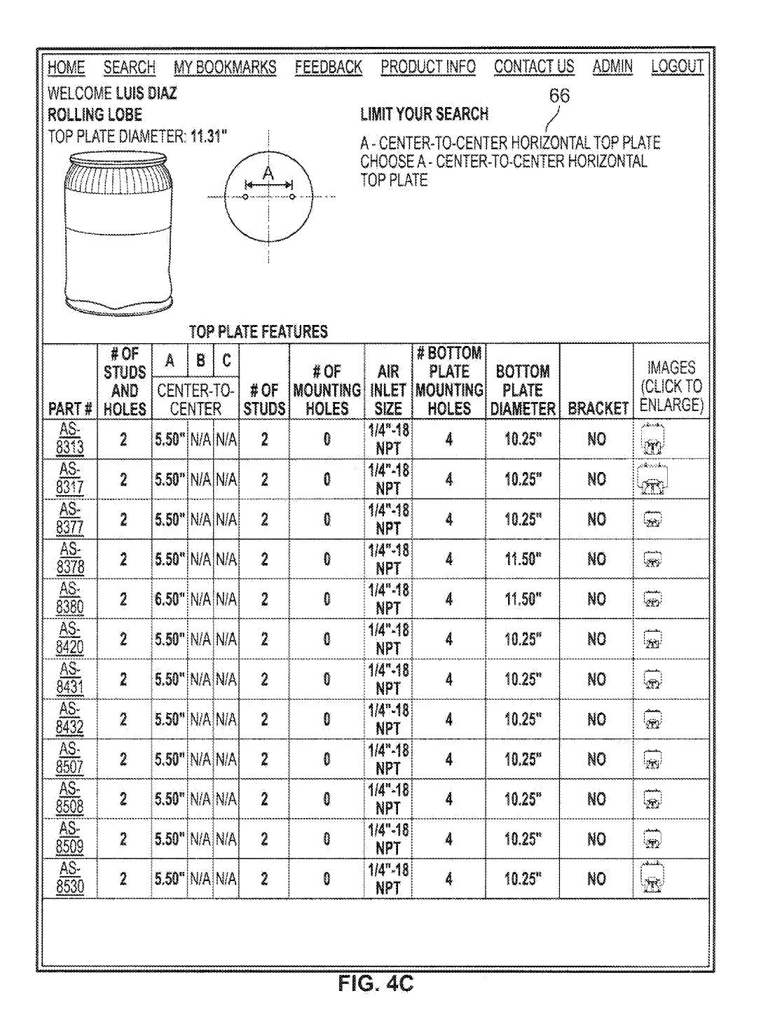

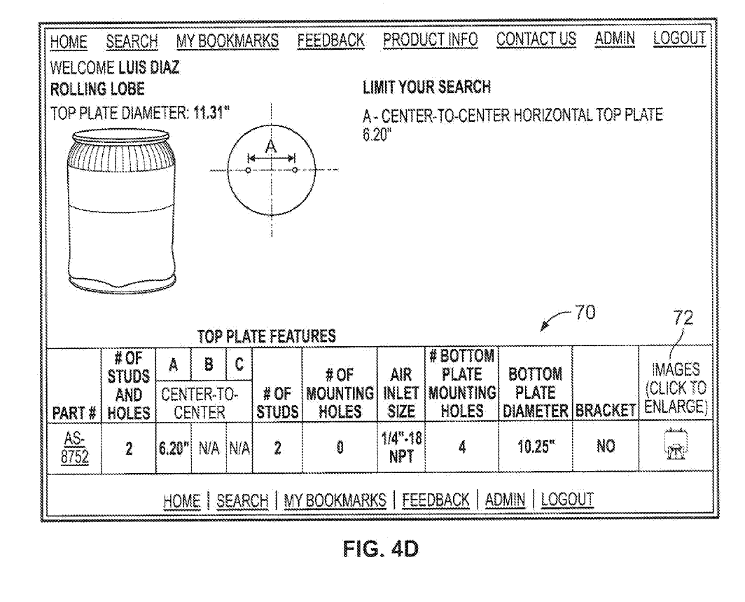

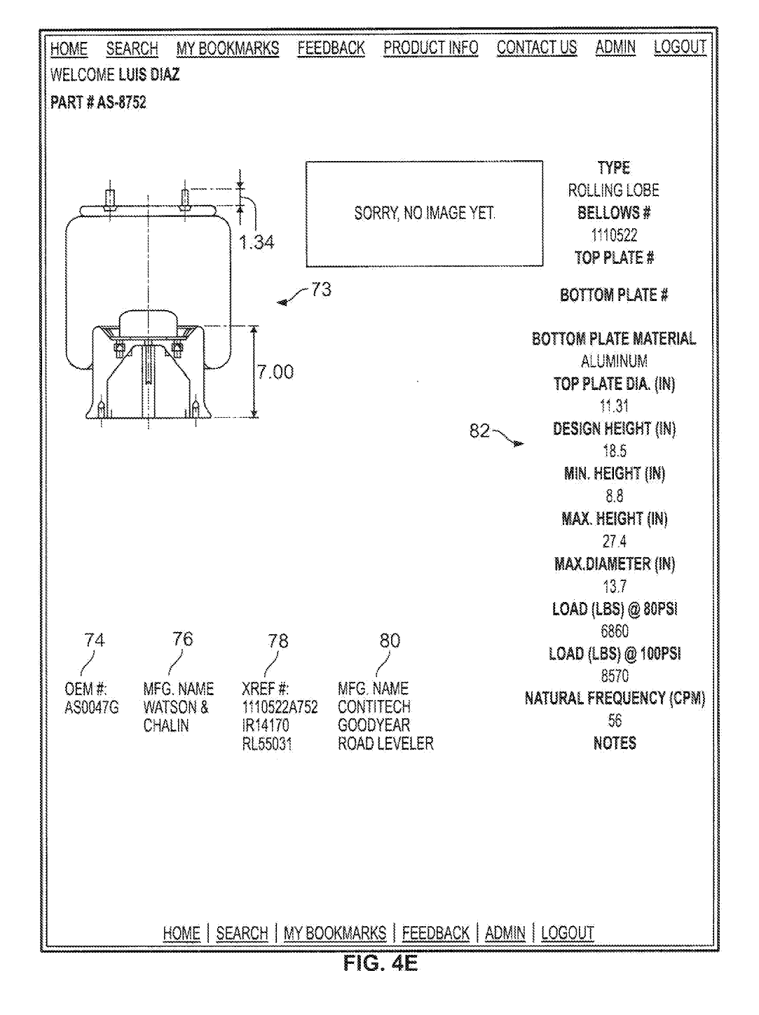

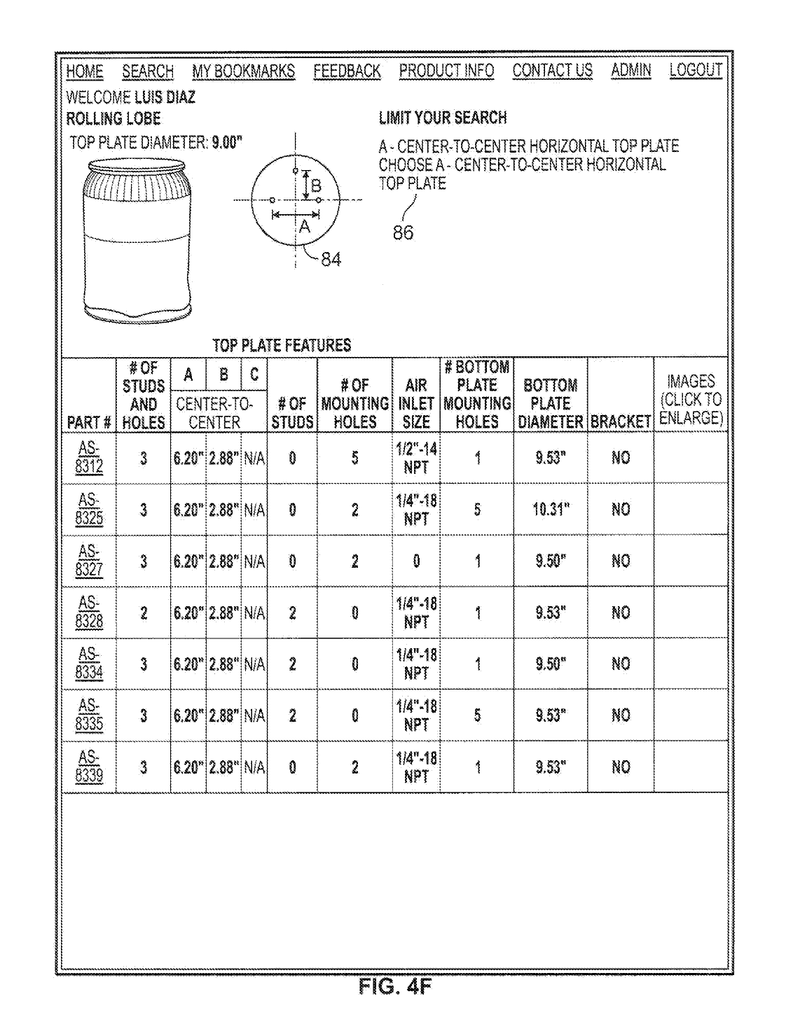

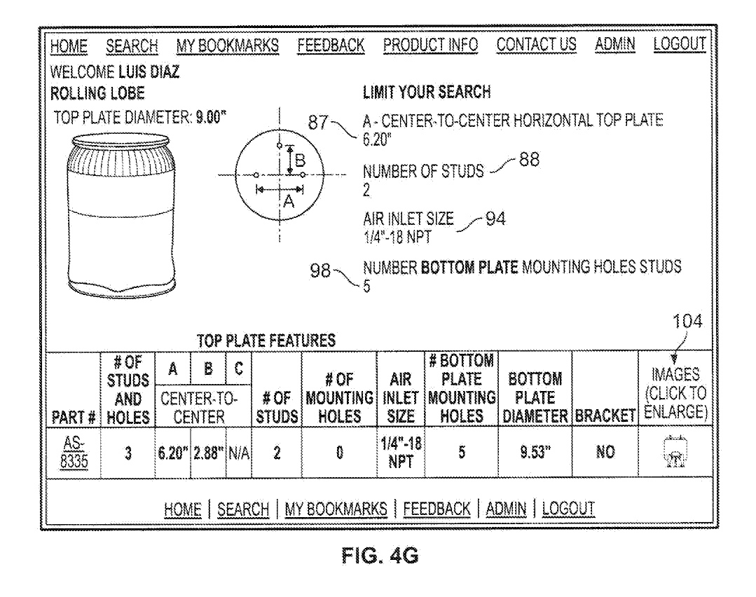

Assuming that the user proceeds with using the drop down menu 48, he or she next clicks on the desired air spring type. This is shown as block 52 in FIG. 3. If the user selects a Rolling Lobe spring type, as illustrated at block 54 in FIG. 3, the screen of FIG. 4A is displayed (such as by workstation 36a in FIG. 1) and prompts the user to “Choose a Top Plate Diameter” for the air spring at 56. This is illustrated as block 58 in FIG. 3. Once the user chooses a top plate diameter from the drop down menu (in this example, 11.31″ was chosen), the screen of FIG. 413 is displayed and presents the user with three images of the top plate, 62a, 62b and 62c, as well as a prompt “Choose a Top Plate Diagram” at 64. This is illustrated by block 66 of FIG. 3. In addition, as in further examples presented herein, FIG. 4B provides a list of air springs that meets the criteria selected thus far. This list is shortened as more steps of FIG. 3 are completed (and more search criteria is added).

Once the user selects a top plate diagram, by clicking on one of images 62a, 62b or 62c, the screen of FIG. 4C is displayed. As shown in FIG. 4C, the user is prompted to choose the length of dimension “A” illustrated in the image at drop down menu 66. This step is shown in block 68 of FIG. 3. Once the dimension “A” is chosen, the screen of FIG. 4D is displayed, which includes a listing 70 for the air spring that fulfills or matches the entered criteria. As in further examples presented herein, if the user clicks on the “Images (click to enlarge)” icon 72, the screen of FIG. 4E is displayed, which provides specifications including an enlarged image 73 of the air spring, along with the OEM part number and manufacturer (74 and 76) and cross reference numbers 78 for other manufacturers 80. In addition, the screen illustrated in FIG. 4E provides dimensions and other specifications for the air spring at 82.

It should be noted that, depending on the selections made by the user, some of the steps of FIG. 3 may be skipped/omitted (for example, after block 58 is completed, jump to block 92).

As another example for a Rolling Lobe air spring, FIG. 4F illustrates the screen displayed when a top plate diameter of 9.00″ and the top plate diagram 84 is selected. The user is again prompted to choose dimension “A” at drop down menu 86 (block 68 of FIG. 3). After the user selects dimension A at 87 in FIG. 4G (6.20″), via successive screens, the user is prompted to select the number of studs 88 (block 92 in FIG. 3), the air inlet size 94 (block 96 in FIG. 3) and the number of bottom plate studs 98 (block 102 of FIG. 3) from drop down menus to arrive at an air spring (104) that meets the entered criteria.

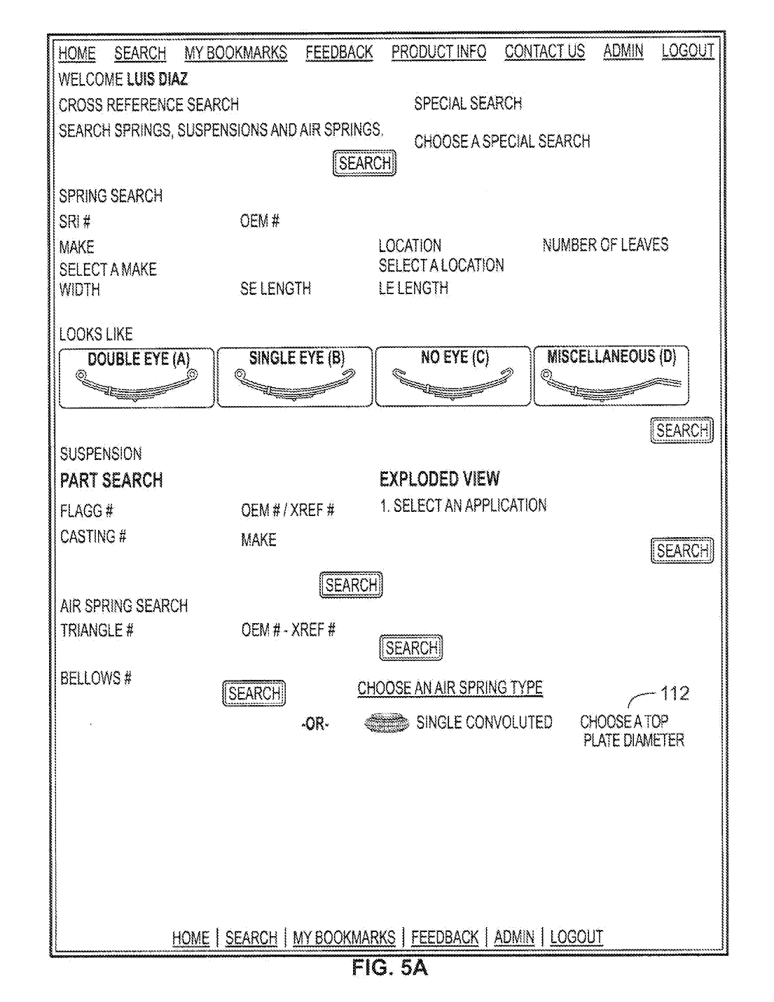

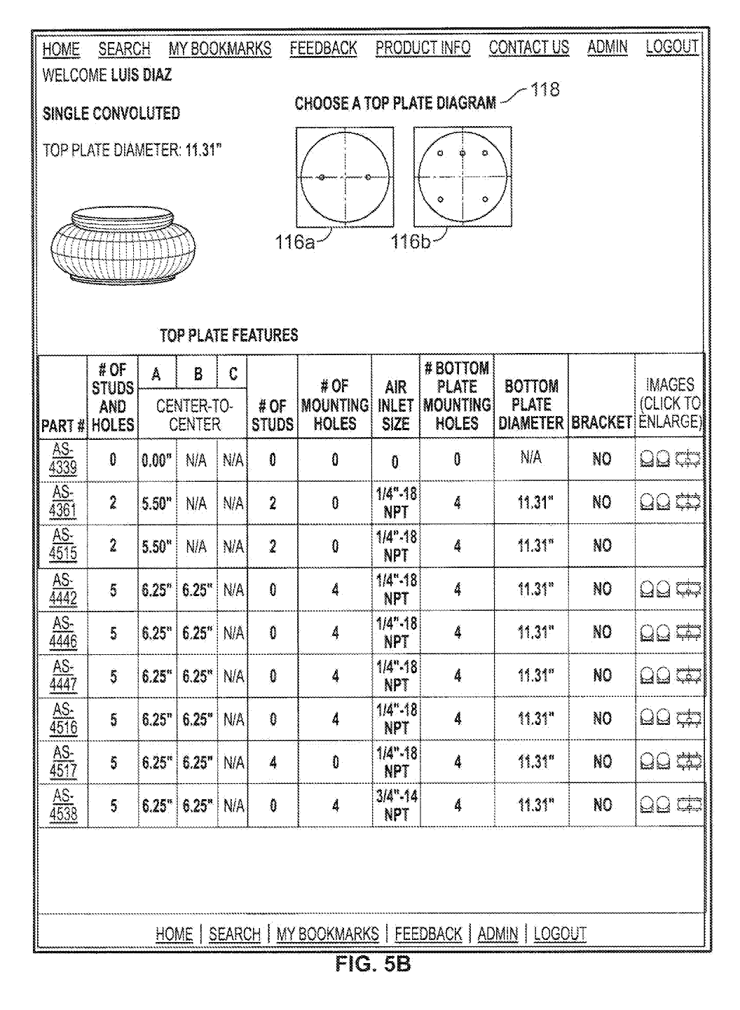

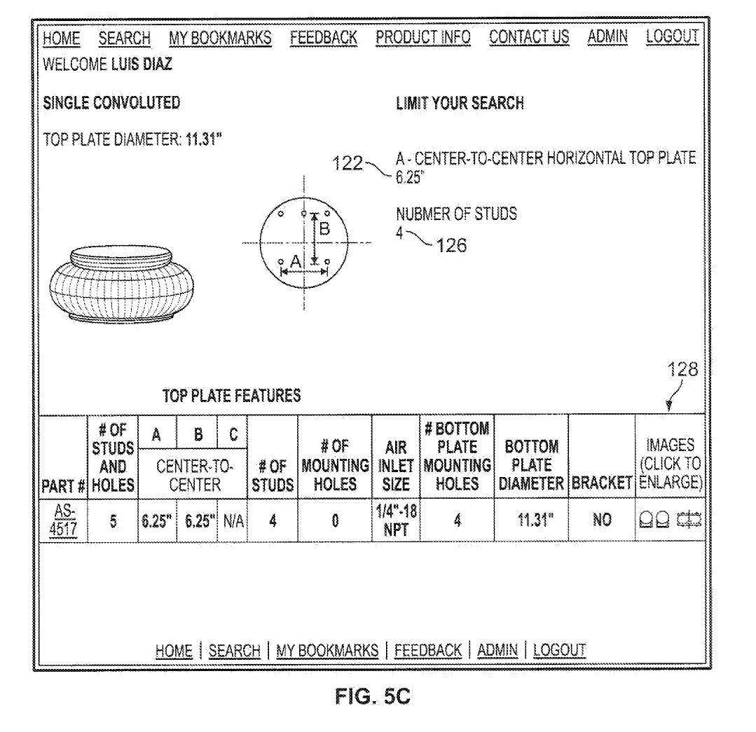

If a Single Convoluted air spring type is selected at 48 in the initial screen of FIG. 2 (block 110 of FIG. 3), the screen of FIG. 5A is displayed and prompts the user to “Choose a Top Plate Diameter” for the air spring at drop down menu 112. This is illustrated as block 114 in FIG. 3. Once the user chooses a top plate diameter from the drop down menu (in this example, 11.31″ was chosen), the screen of FIG. 5B is displayed and presents the user with two images of the top plate, 116a and 116b, as well as a prompt “Choose a Top Plate Diagram” at 118. This is illustrated by block 120 of FIG. 3.

Once the user selects a top plate diagram, by clicking on one of images 116a or 116b, the screen of FIG. 5C is displayed. As shown in FIG. 5C, the user is prompted to choose the length of dimension “A” at drop down menu 122. This step is shown in block 124 of FIG. 3. In the following screen, the user is prompted to select the number of studs at drop down menu 126 (block 102 in FIG. 3). This results in the display of a listing 128 for the air spring that fulfills the entered criteria on the screen of FIG. 5C.

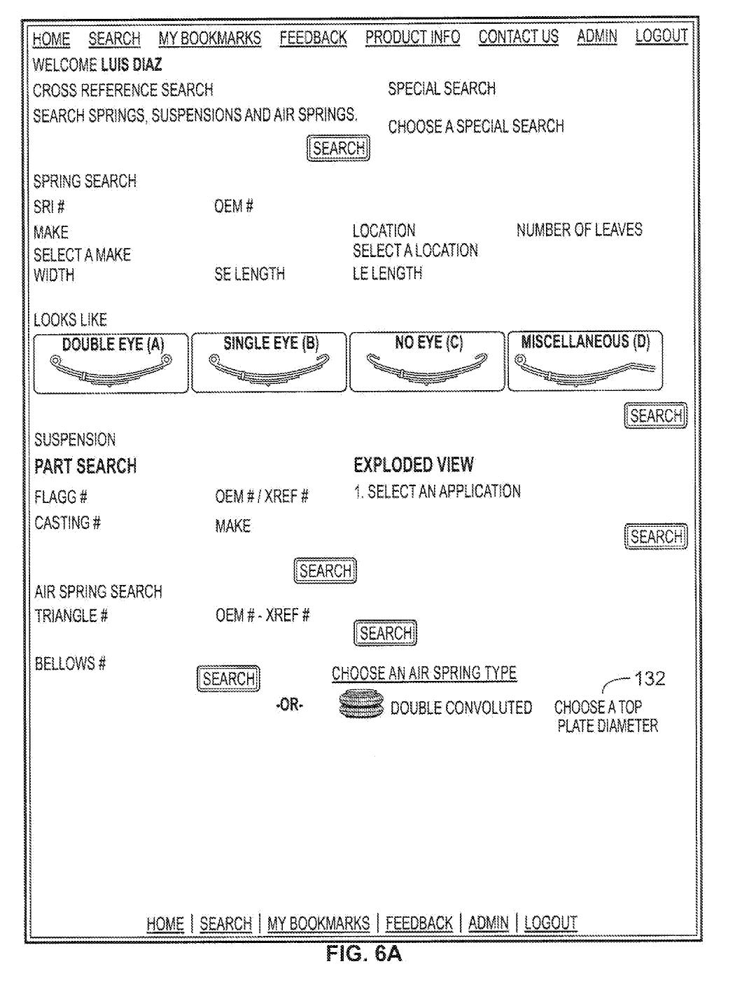

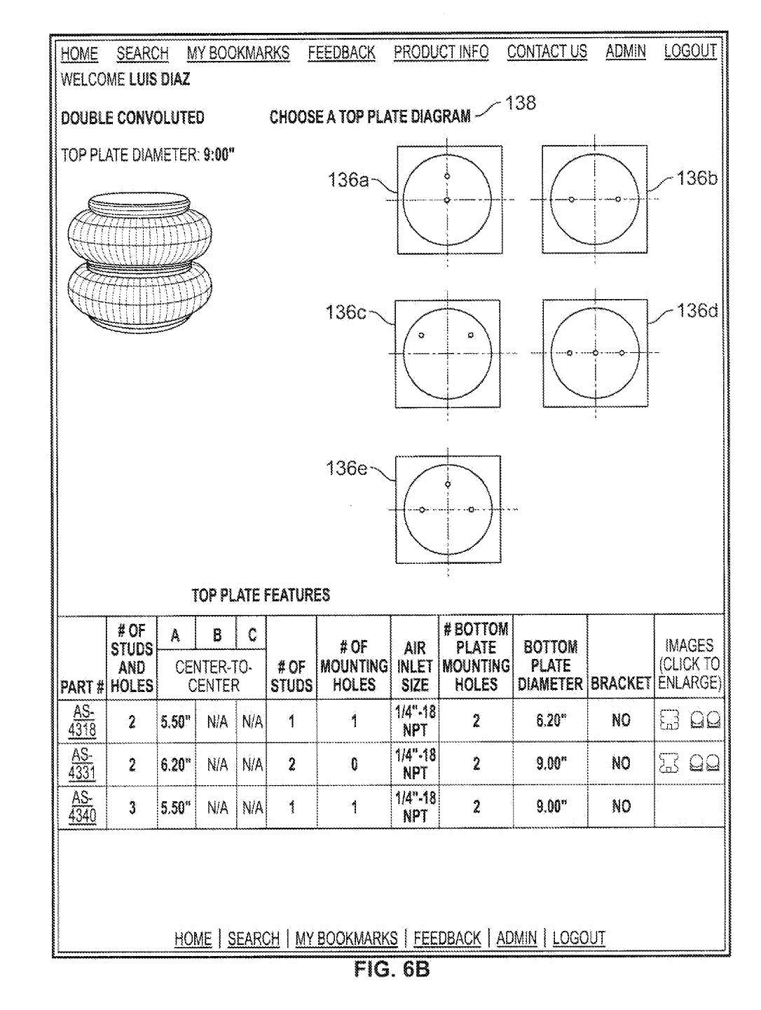

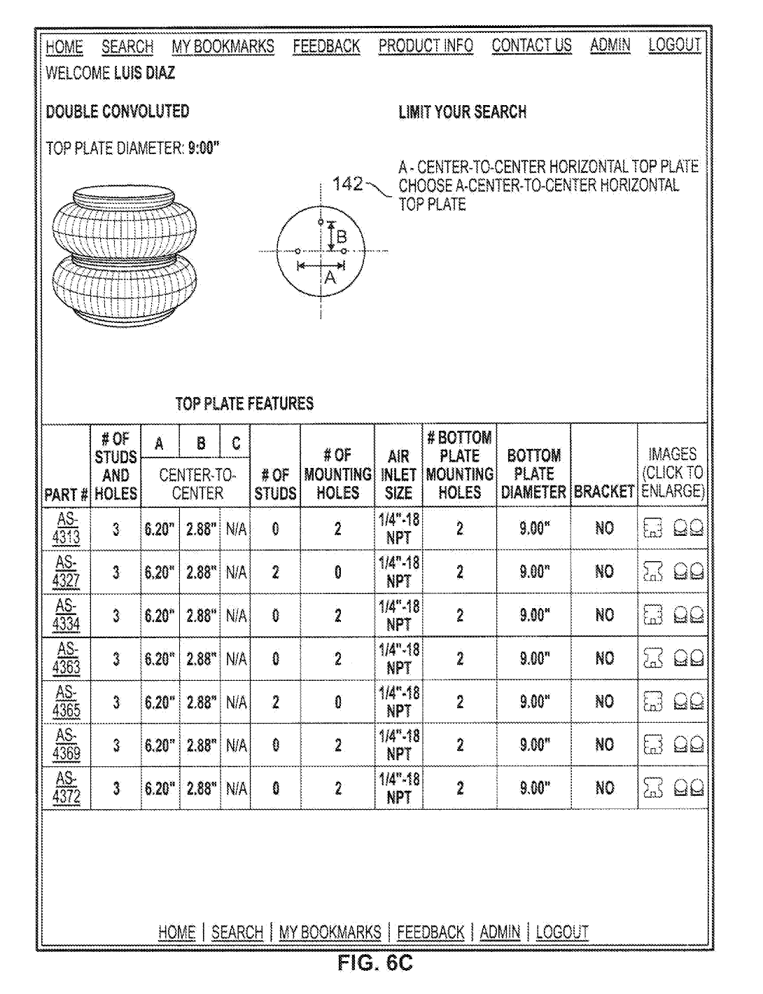

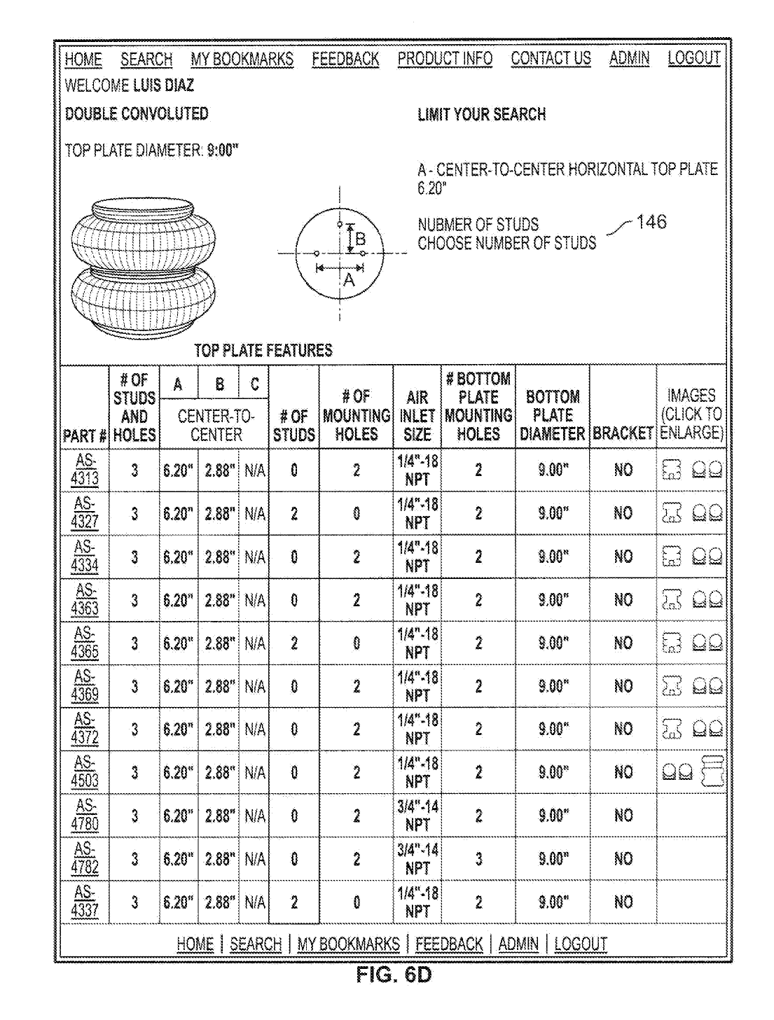

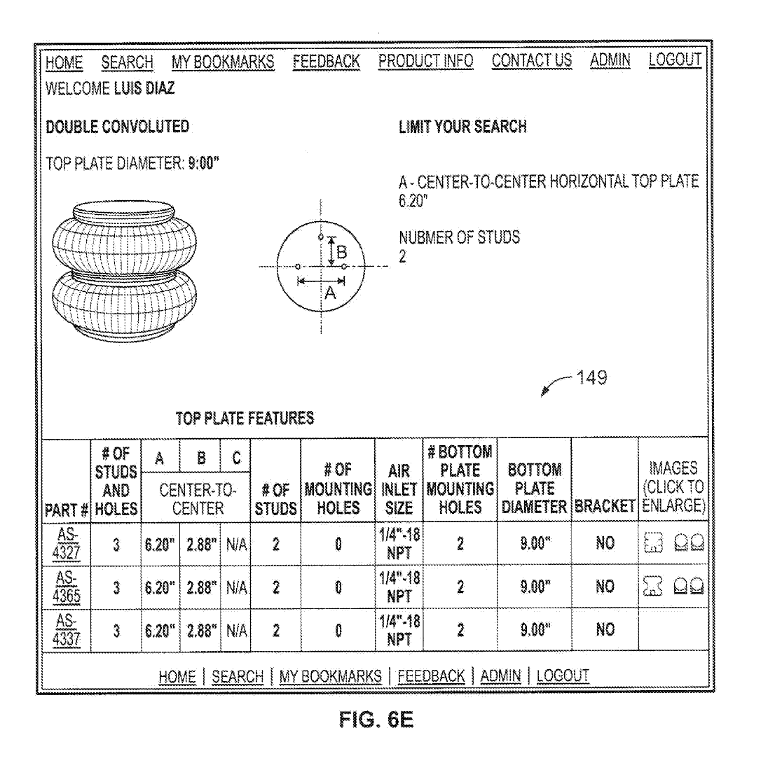

If a Double Convoluted air spring type is selected at 48 in the initial screen of FIG. 2 (block 130 of FIG. 3), the screen of FIG. 6A is displayed and prompts the user to “Choose a Top Plate Diameter” for the air spring at 132. This is illustrated as block 134 in FIG. 3. Once the user chooses a top plate diameter from a drop down menu (in this example, 9.0″ was chosen), the screen of FIG. 6B is displayed and presents the user with five images of the top plate, 136a-136e. as well as a prompt “Choose a Top Plate Diagram” at 138. This is illustrated by block 140 of FIG. 3.

Once the user selects a top plate diagram, by clicking on one of images 136a-136e, the screen of FIG. 6C is displayed. As shown in FIG. 6C, the user is prompted to choose the length of dimension “A” at drop down menu 142. This step is shown in block 144 of FIG. 3. In the following screen, illustrated in FIG. 6D, the user is prompted to select the number of studs at drop down menu 146 (block 148 in FIG. 3). Selection of the number of studs results in the display of FIG. 6E, which provides a listing 149 for the air springs that fulfill the entered criteria.

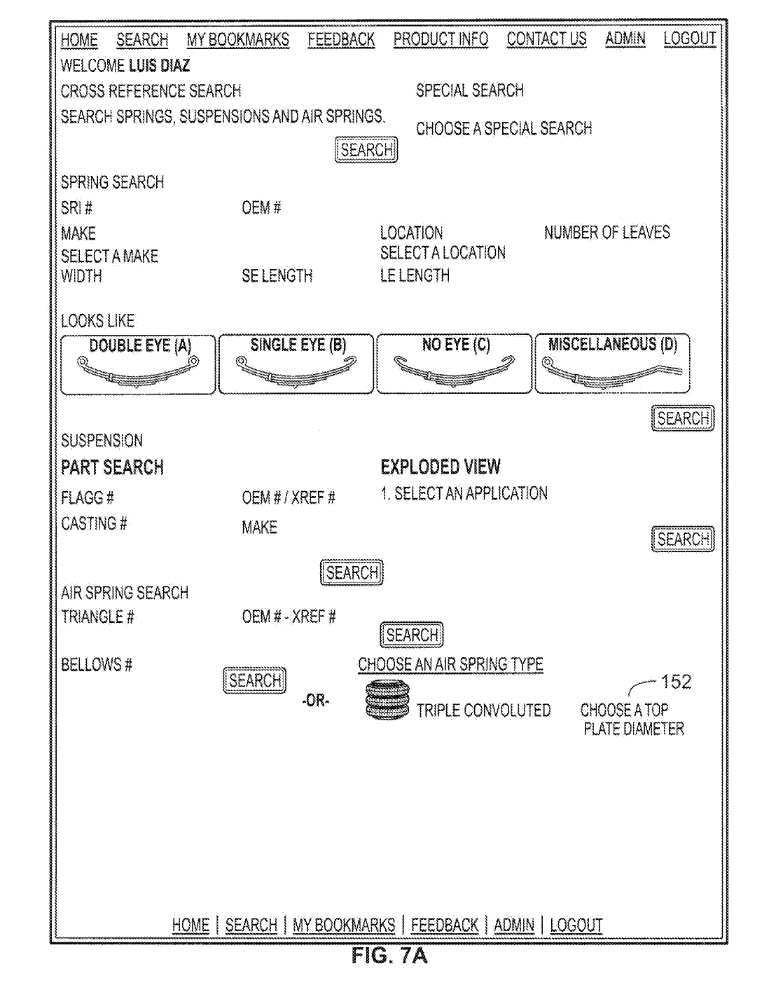

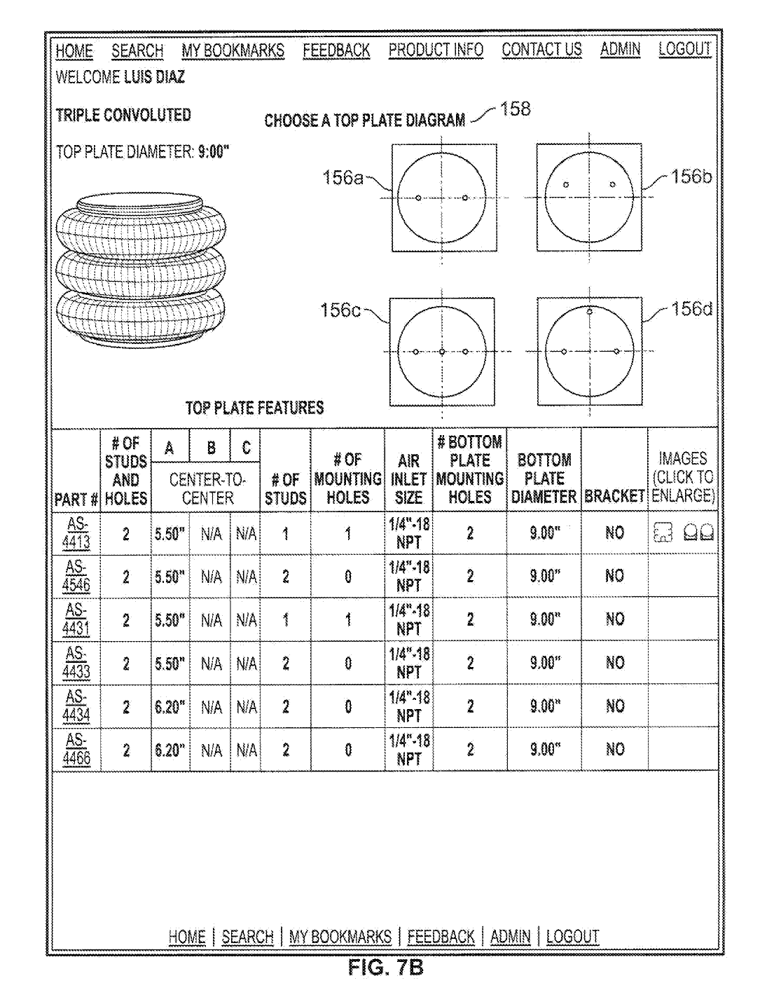

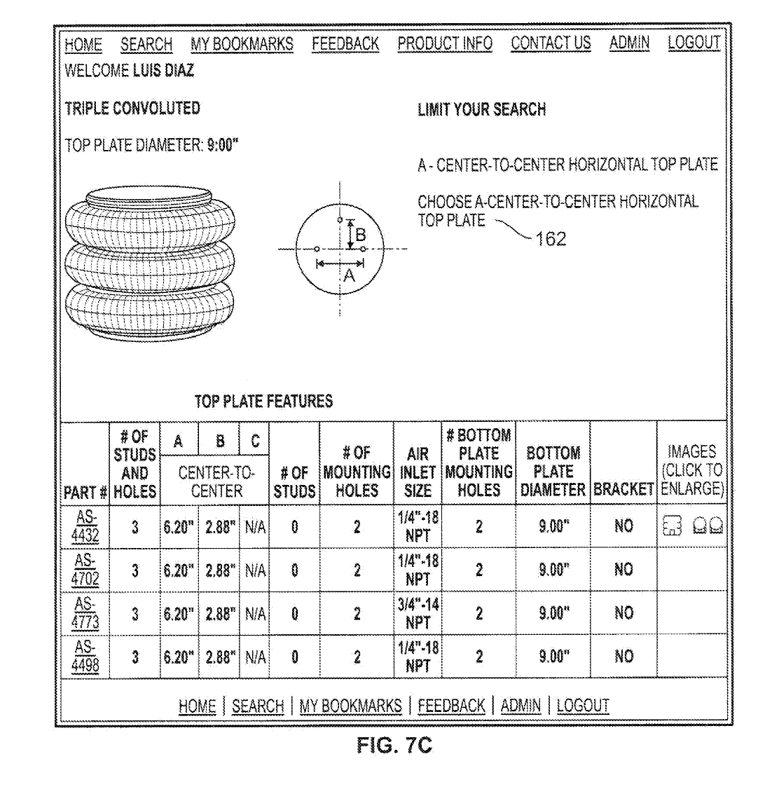

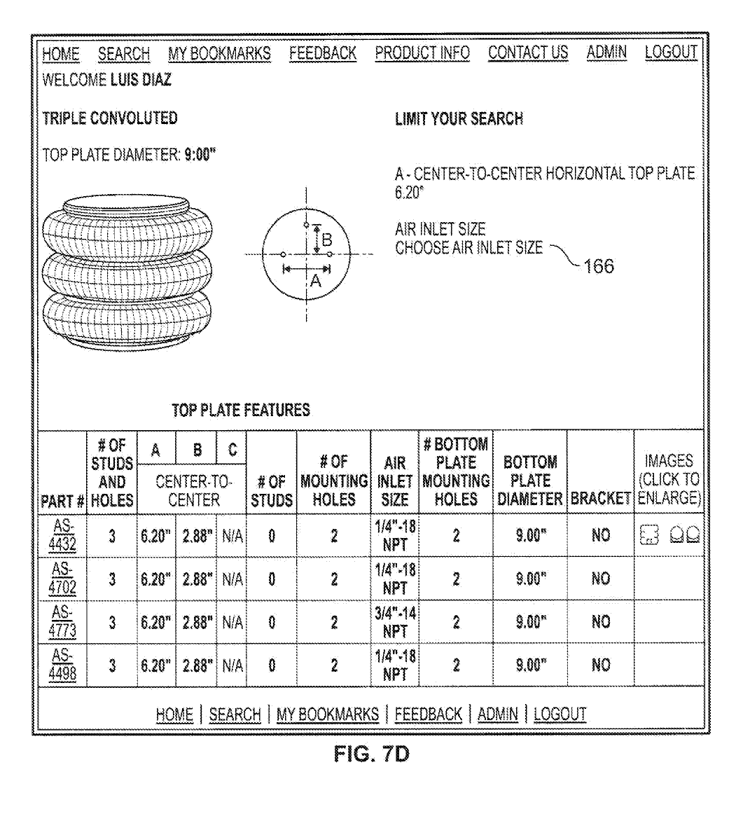

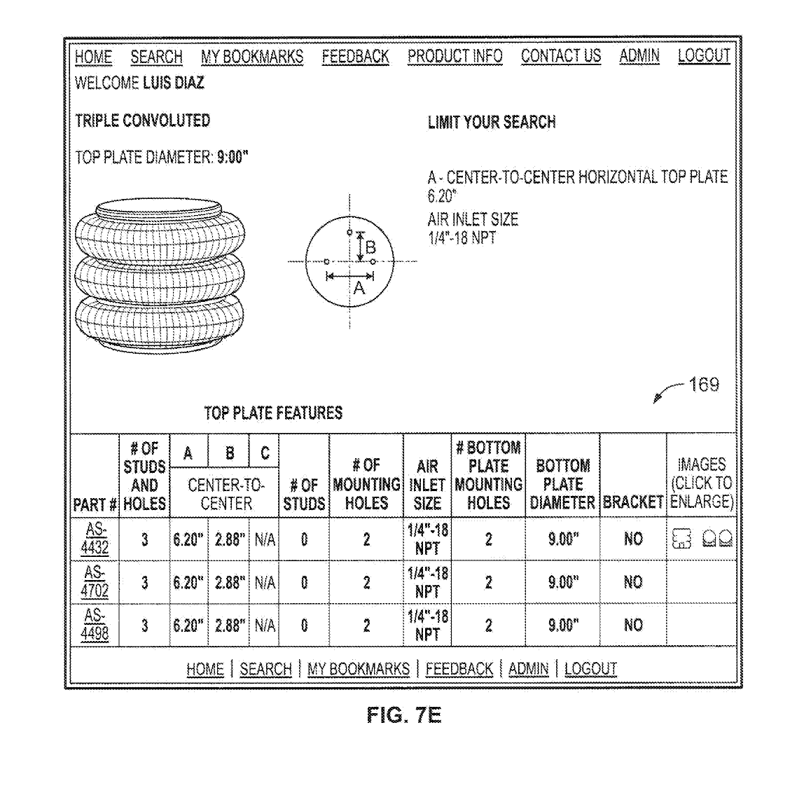

If a Triple Convoluted air spring type is selected at 48 in the initial screen of FIG. 2 (block 150 of FIG. 3), the screen of FIG. 7A is displayed and prompts the user to “Choose a Top Plate Diameter” for the air spring at drop down menu 152. This is illustrated as block 154 in FIG. 3. Once the user chooses a top plate diameter from the drop down menu (in this example, 9.0″ was chosen), the screen of FIG. 7B is displayed and presents the user with four images of the top plate, 156a-156d, as well as a prompt “Choose a Top Plate Diagram” at 158. This is illustrated by block 160 of FIG. 3.

Once the user selects a top plate diagram, by clicking on one of images 156a-156d, the screen of FIG. 7C is displayed. As shown in FIG. 7C, the user is prompted to choose the length of dimension “A” at drop down menu 162. This step is shown in block 164 of FIG. 3. In the following screen, illustrated in FIG. 7D, the user is prompted to select the air inlet size at drop down menu 166 (block 168 in FIG. 3). Selection of the air inlet size results in the screen of FIG. 7E being displayed, which provides a listing 169 for the air springs that fulfill the entered criteria.

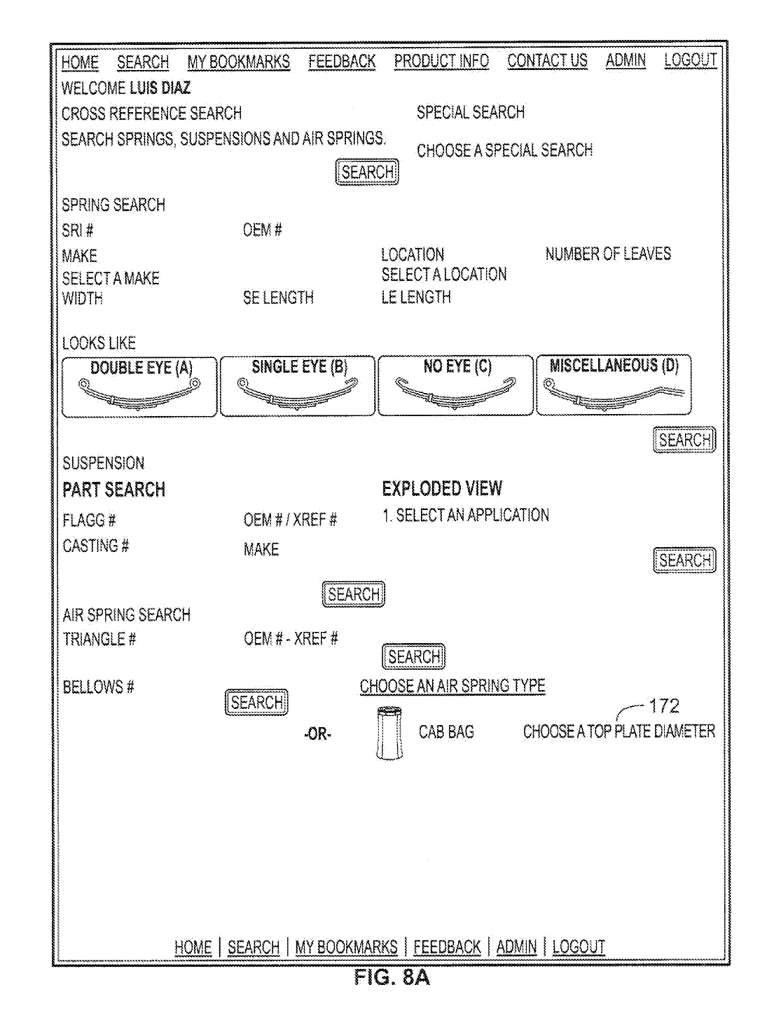

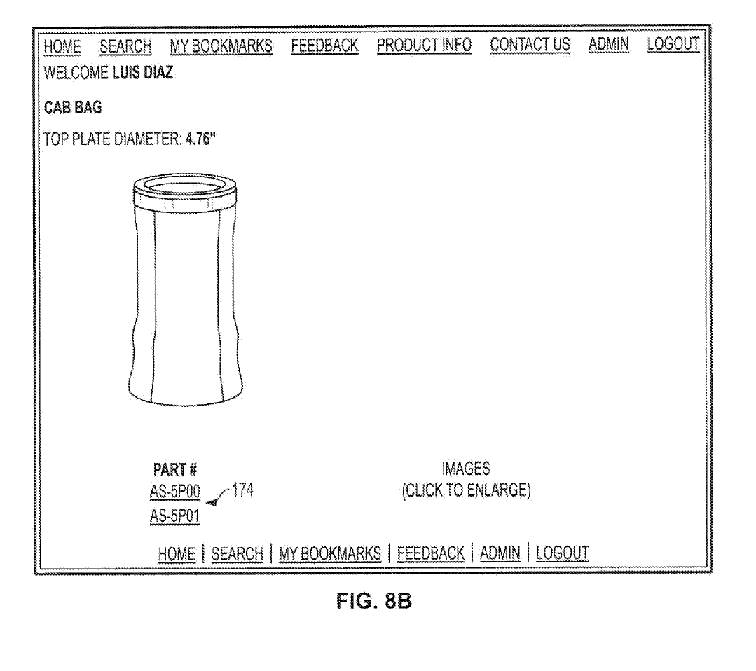

If a Cab Bag air spring type is selected at 48 in the initial screen of FIG. 2 (block 170 of FIG. 3), the screen of FIG. 8A is displayed and prompts the user to “Choose a Top Plate Diameter” for the air spring at drop down menu 172. This is illustrated as block 174 in FIG. 3. Once the user chooses a top plate diameter from the drop down menu (in this example, 4.76″ was chosen), the screen of FIG. 8B is displayed and provides a listing 174 for the air springs that fulfill the entered criteria.

With reference to the initial screen of FIGS. 2A and 2B, and as noted previously, a Bellows Number for the desired air spring may be entered in field 44 instead of selecting an Air Spring Type by use of pull down menu 48. This is illustrated at block 180 in FIG. 3. Because the Bellows Number is directly related to the type of bag and top plate diameter, as illustrated in FIG. 3, the system immediately jumps to the prompts of blocks 66, 120, 140 or 160 when a Bellows Number is entered.

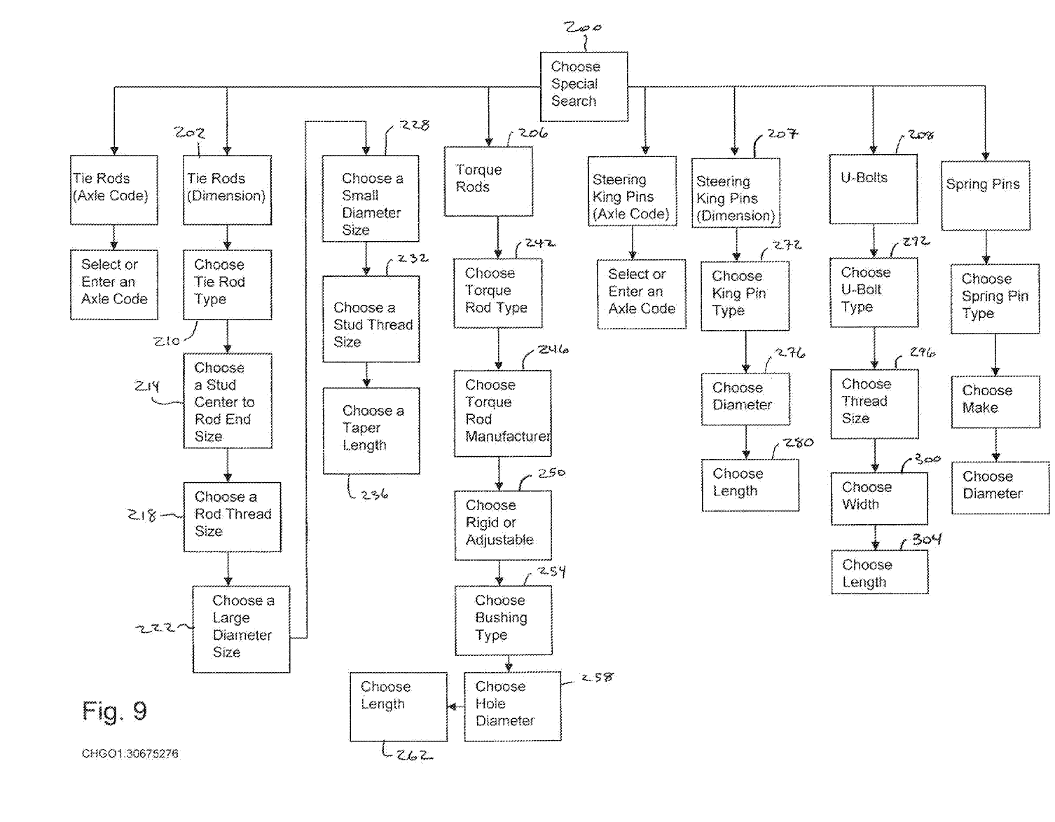

The system may also be used to identify suspension components other than air springs via a “special search.” Such components may be selected from the Special Search drop down menu 182 of the initial screen of FIG. 2, as indicated by block 200 of FIG. 9.

With reference to FIG. 9, as an example, the components that may be selected from drop down menu 182 of the initial screen (FIG. 2) may include Tie Rods (by Dimension) 202, Torque Rods 206, Steering King Pins (by Dimension) 207, U-Bolts 208, Spring Pins 320, Tie Rods (by Axle Code) 322 and Steering King Pins (by Axle Code) 324.

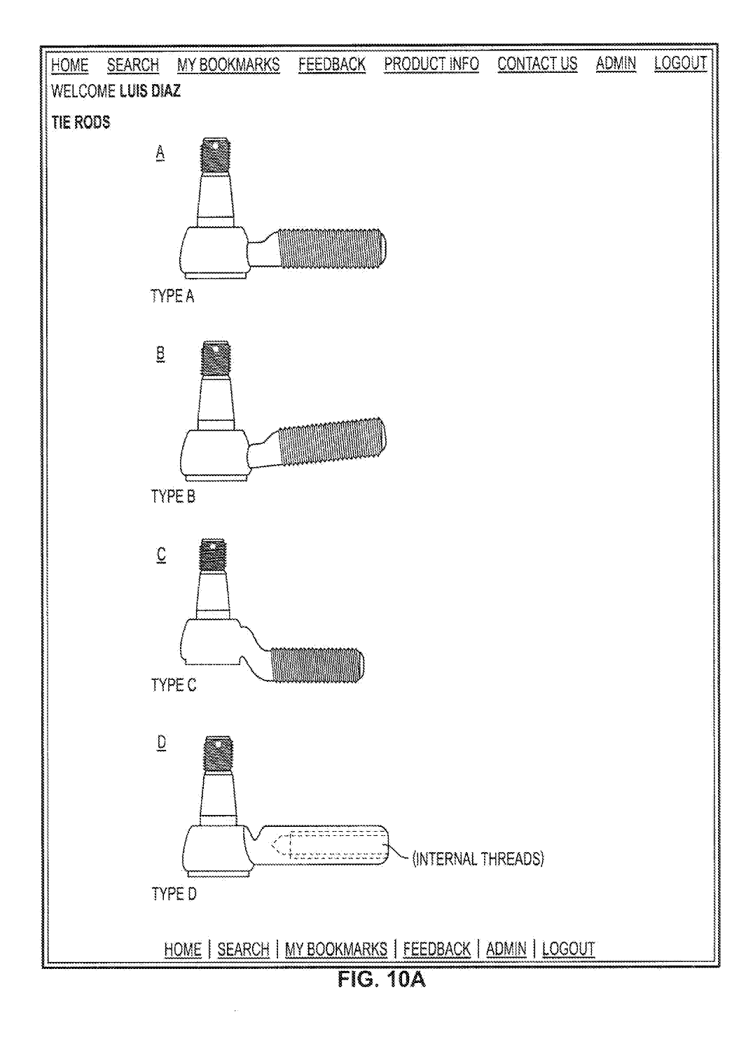

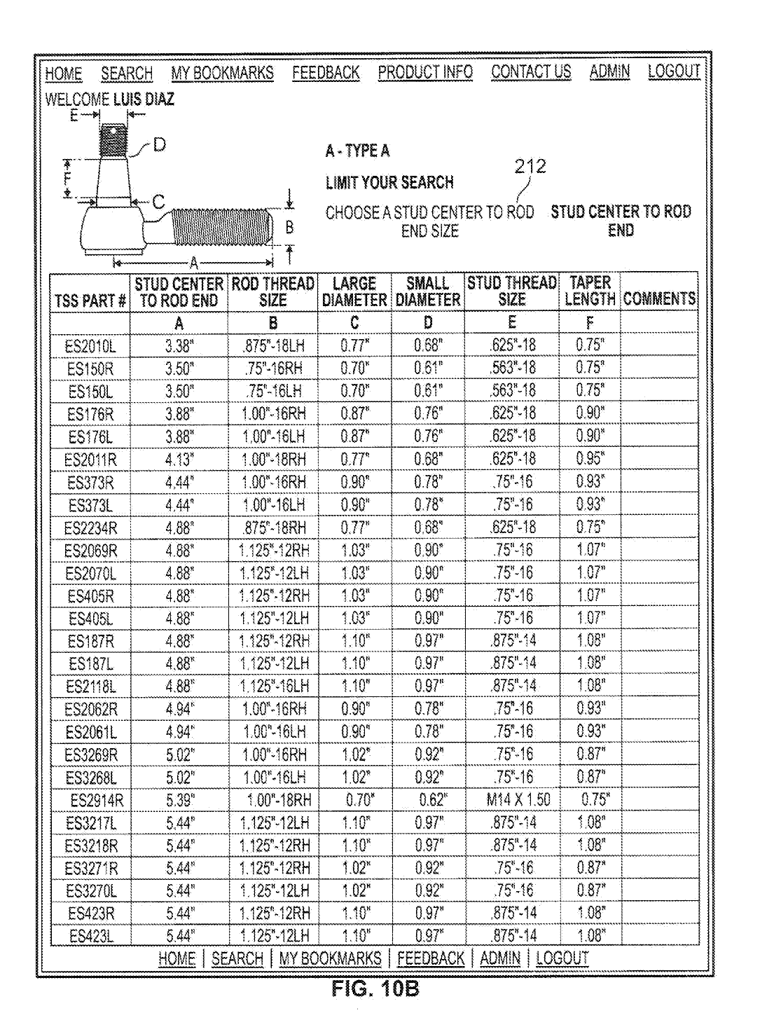

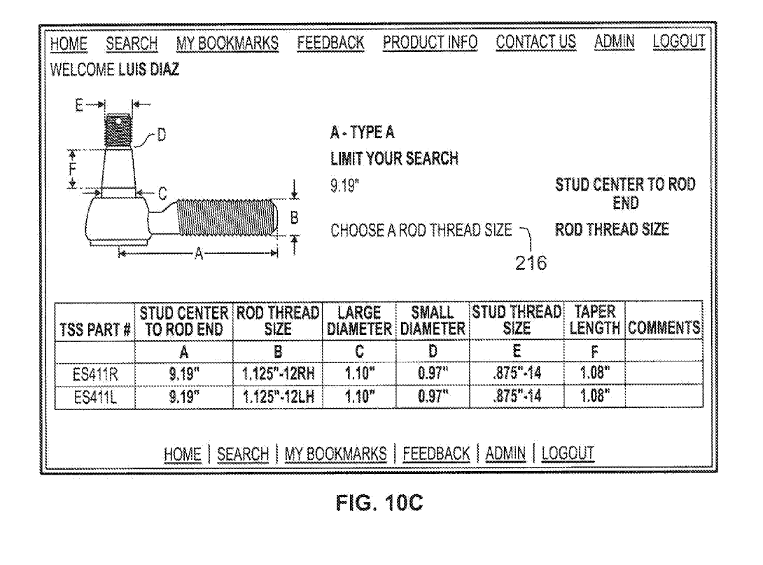

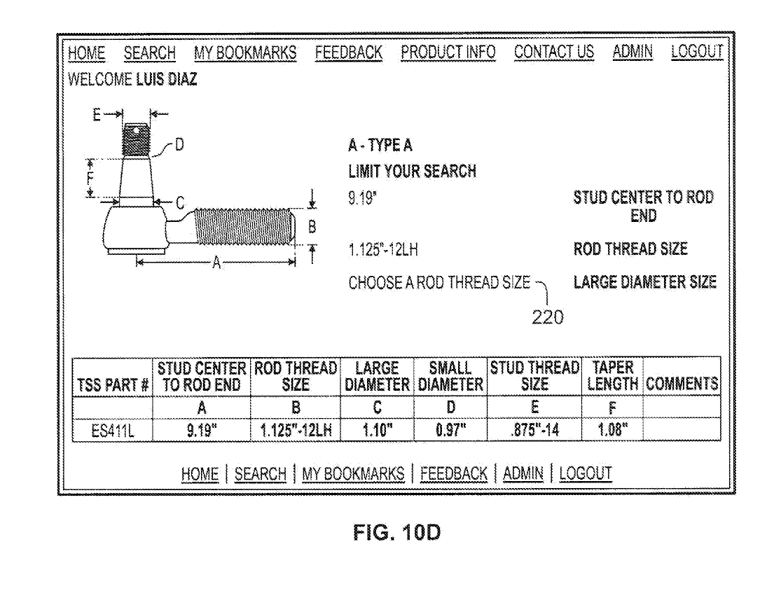

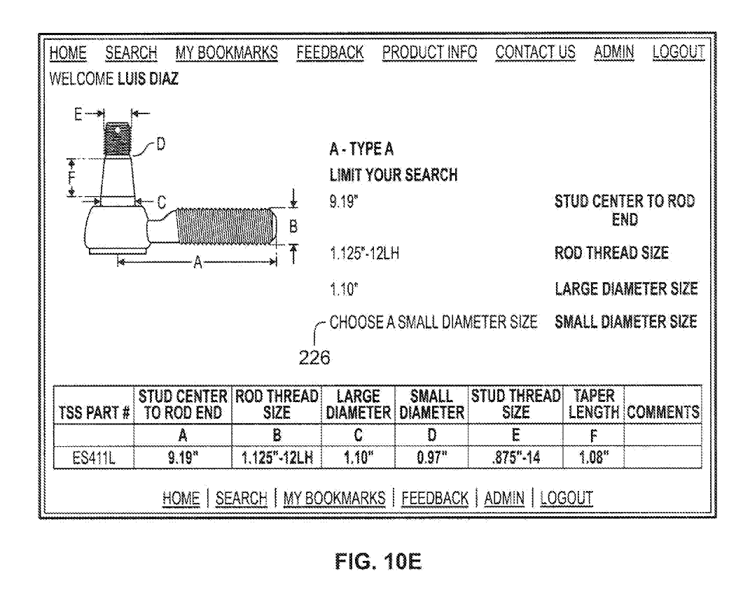

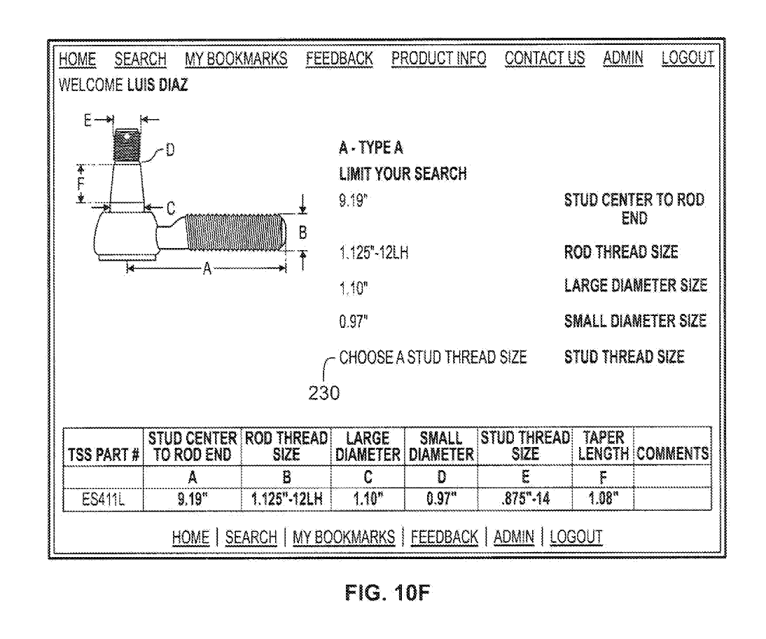

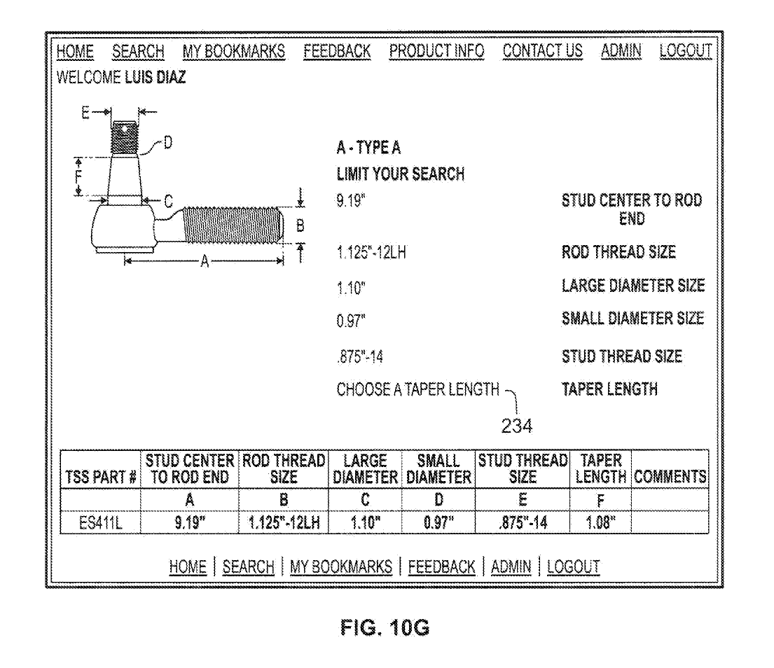

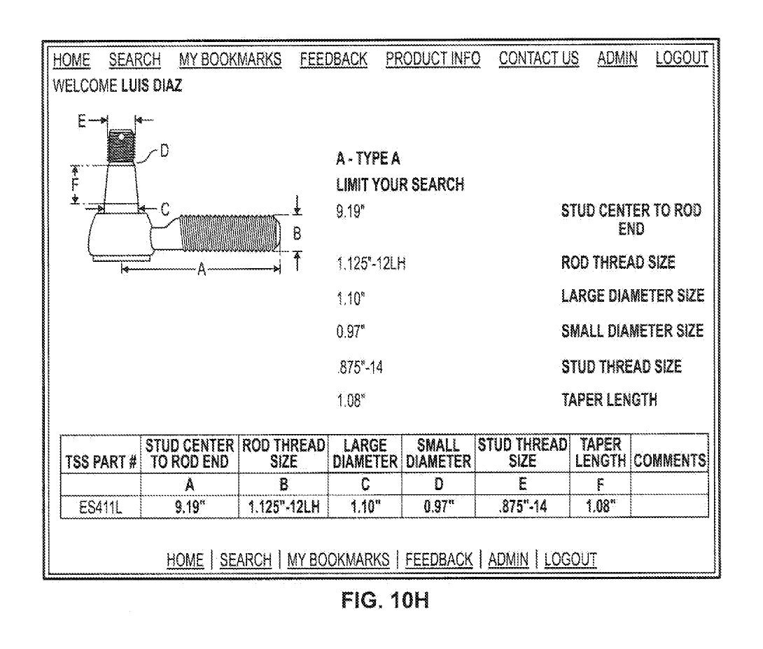

If Tie Rods (by Dimension) are selected from the initial screen (block 202 in FIG. 9), the screen of FIG. 10A is displayed where the user may select between tie rod types A-D. Once the user selects a tie rod type (block 210 in FIG. 9), for example, type A, the screen of FIG. 10B is displayed. The user is prompted to choose a stud center to rod end size via drop down menu 212 (block 214 in FIG. 9). Once this selection is made, the screen of FIG. 10C is displayed, which prompts the user to choose a rod thread size via pull down menu 216 (block 218 in FIG. 9). Once this selection is made, the screen of FIG. 10D is displayed, which prompts the user to choose a large diameter size via pull down menu 220 (block 222 in FIG. 9).

While not required in this example, since the tie rod corresponding to the entered search criteria is identified at 224 in the screen of FIG. 10), additional narrowing search criteria may be entered if more than one tie rod is listed at 224. More specifically, as illustrated by the screen of FIG. 10E, a small diameter size may be entered via pull down menu 226 (block 228 of FIG. 9), a stud thread size may be entered via drop down menu 230 of the screen of FIG. 10F (block 232 of FIG. 9) and a taper length may be entered via pull down menu 234 of the screen of FIG. 10G (block 236 of FIG. 9). As in the further examples presented herein, clicking on the listed tie rod (224 of FIG. 10D) causes the screen of FIG. 10H to be displayed, which provides an enlarged illustration and dimensions for the tie rod.

It should be noted that, as with FIG. 3, depending on the selections made by the user, some of the steps of FIG. 9 may be skipped/omitted.

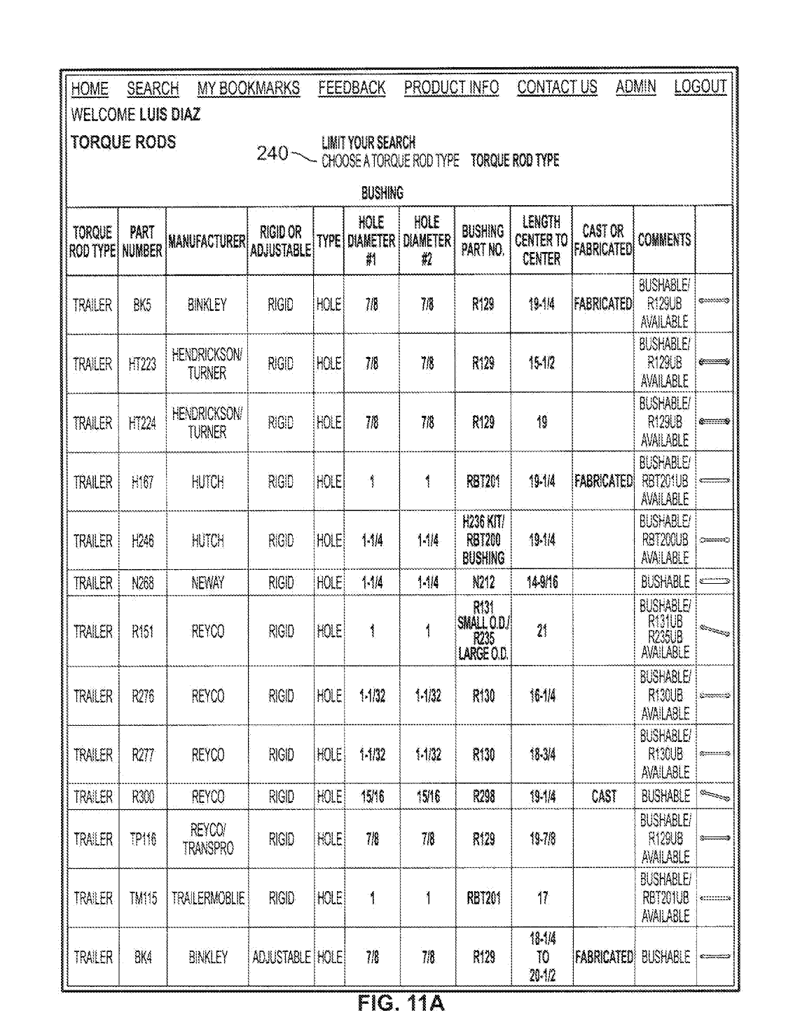

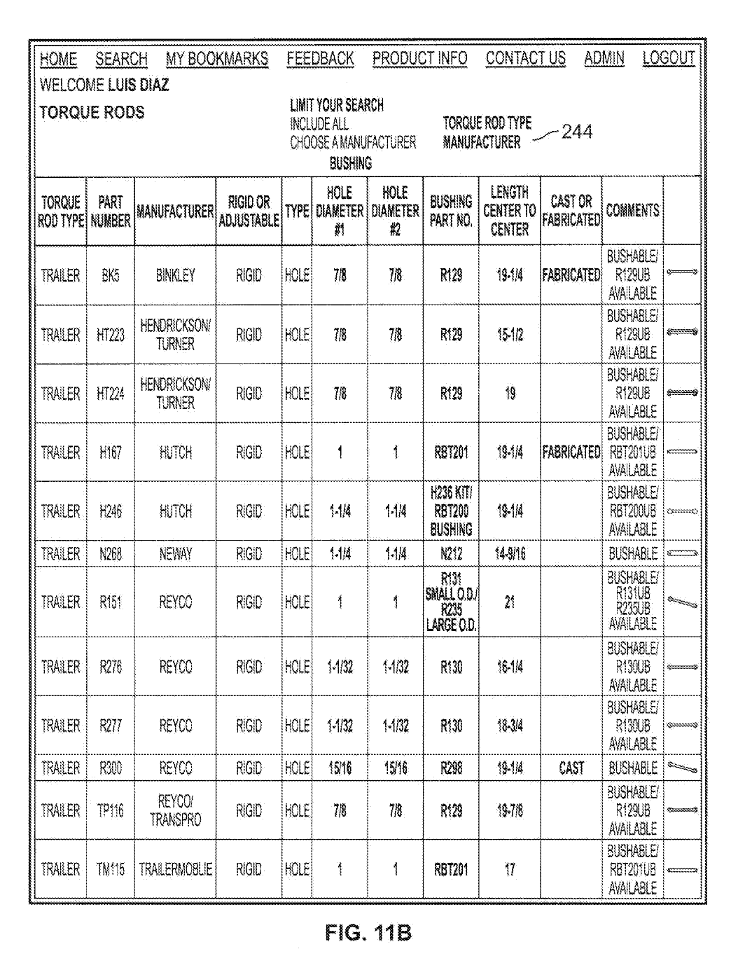

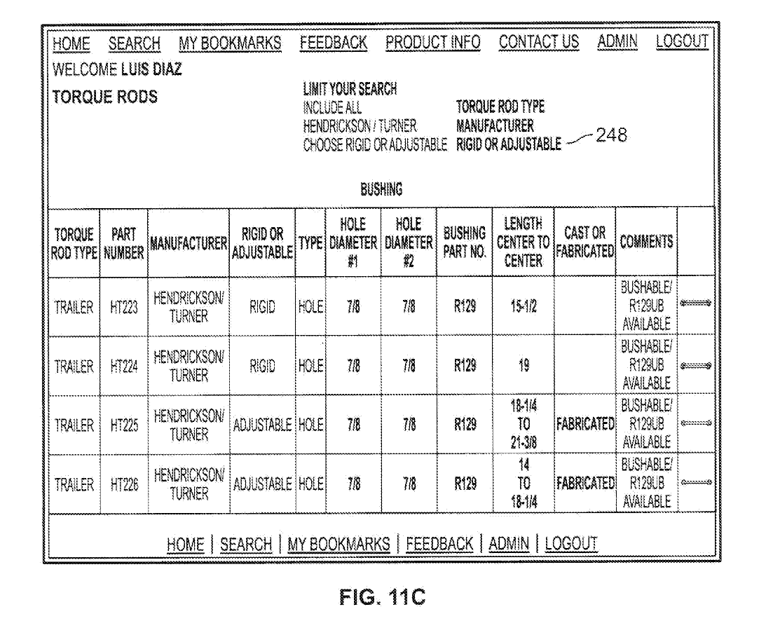

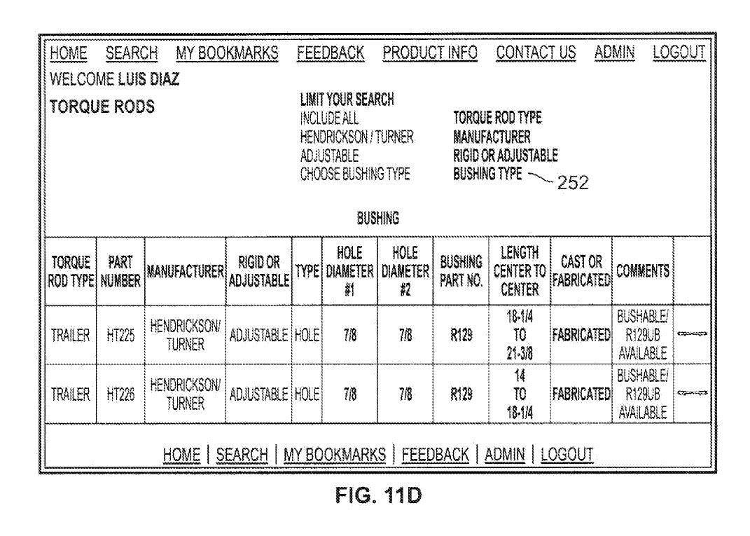

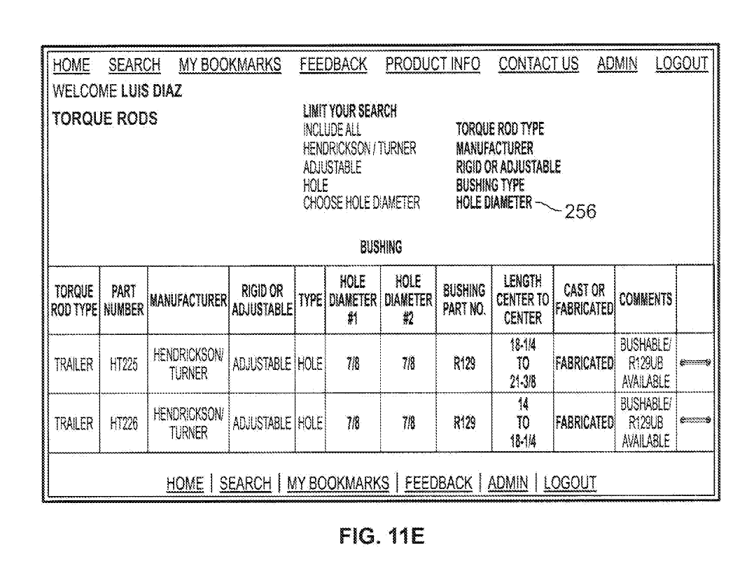

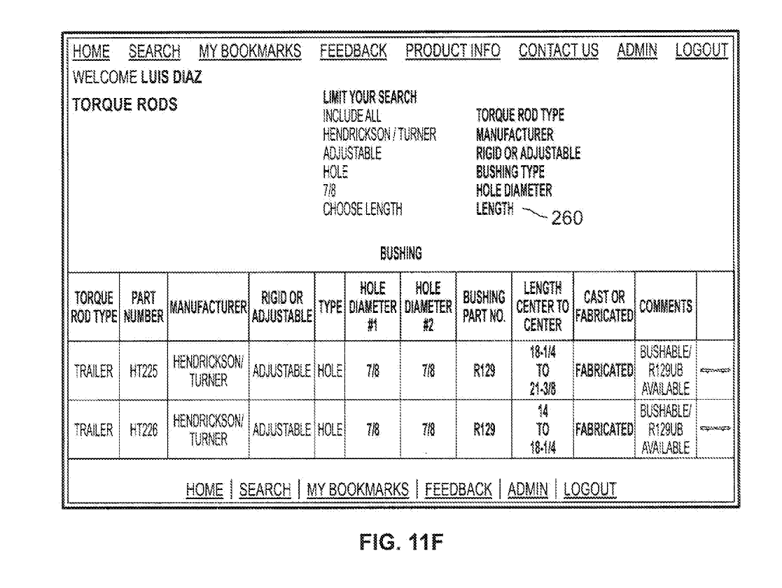

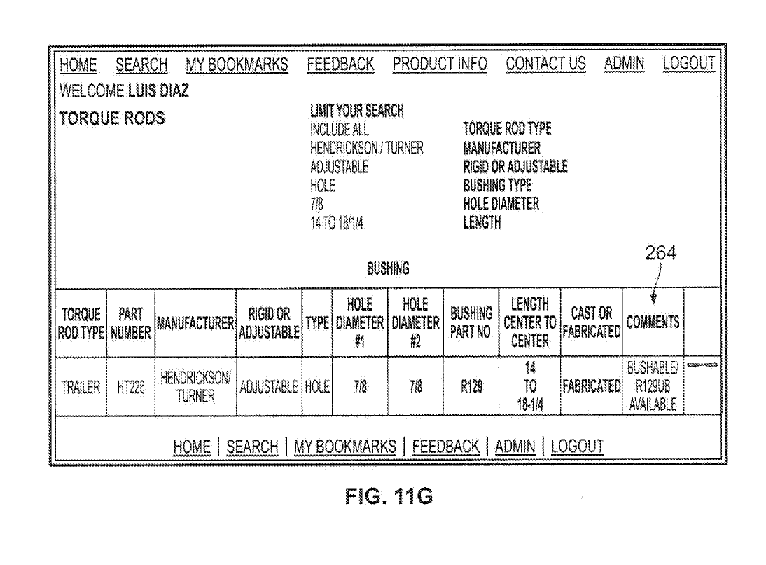

If Torque Rods are selected from the initial screen (block 206 in FIG. 9), the screen of FIG. 11A is displayed where the user may select between, or to include all, tie rod types via drop down menu 240. Once the user selects a tie rod type (block 242 in FIG. 9) or all tie rod types (as in the present example), the screen of FIG. 11B is displayed. The user is prompted to choose a manufacturer via drop down menu 244 (block 246 in FIG. 9). Once this selection is made, the screen of FIG. 11C is displayed, which prompts the user to choose between a rigid or adjustable torque rod via pull down menu 248 (block 250 in FIG. 9). Once this selection is made, the screen of FIG. 11D is displayed, which prompts the user to choose a bushing type via pull down menu 252 (block 254 in FIG. 9). Once this selection is made, the screen of FIG. 11E is displayed, which prompts the user to choose a hole diameter via pull down menu 256 (block 258 in FIG. 9). Once this selection is made, the screen of FIG. 11F is displayed, which prompts the user to choose a length via pull down menu 260 (block 262 in FIG. 9). Once this selection is made, the tie rod corresponding to the entered search criteria is identified at 264 in FIG. 11G.

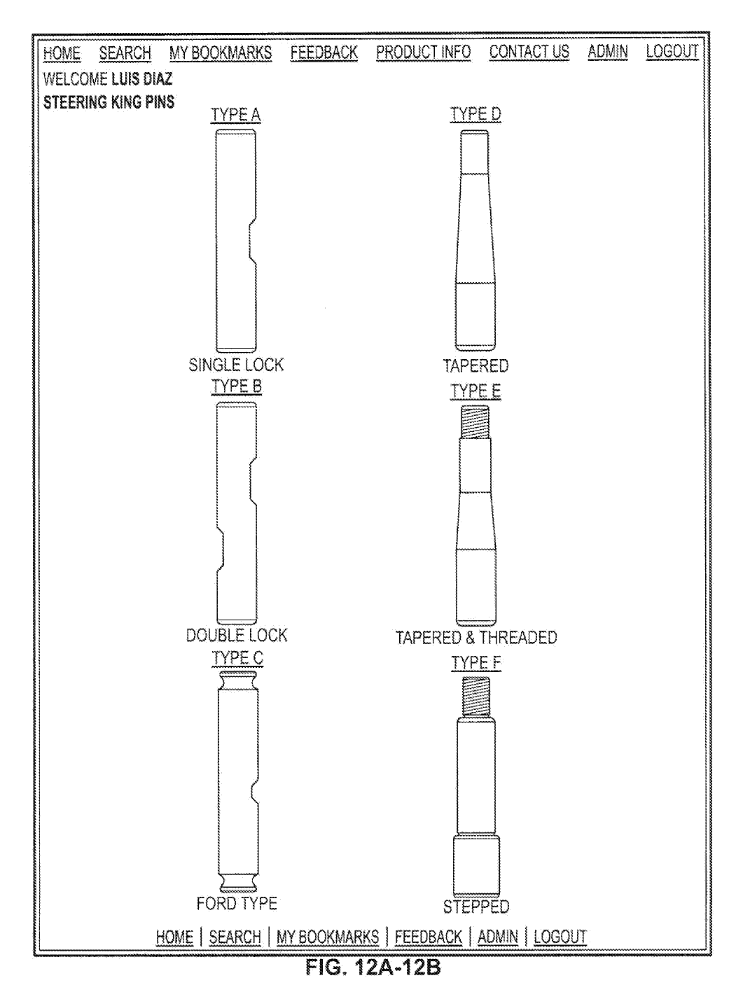

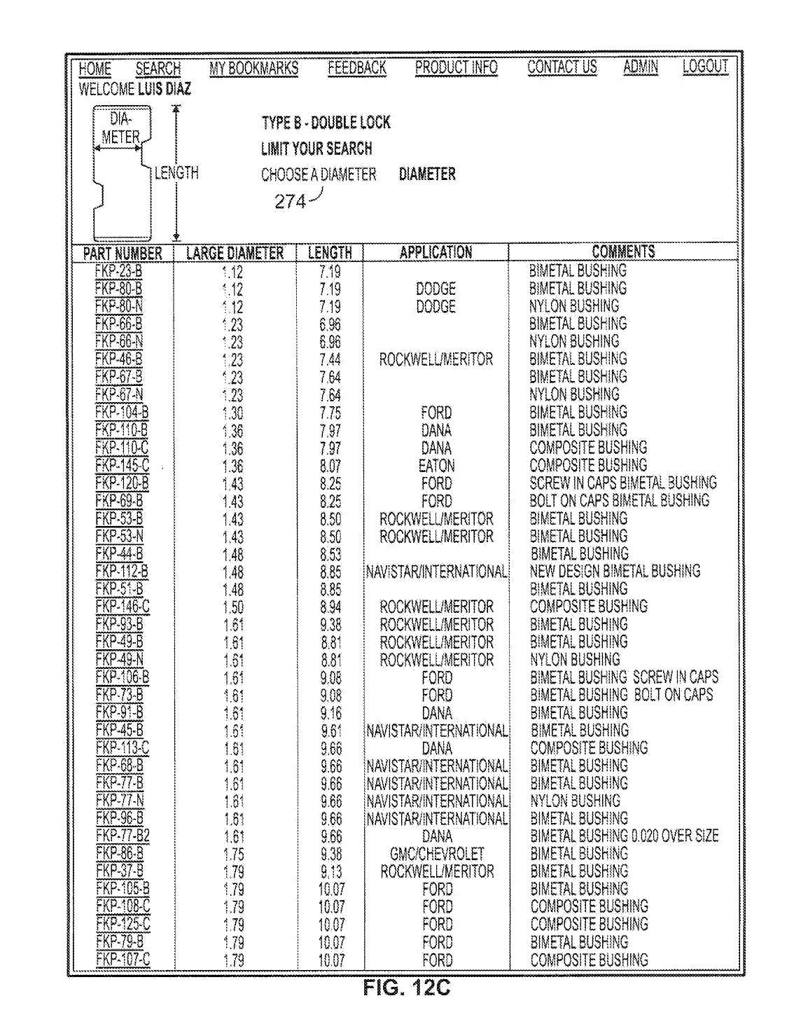

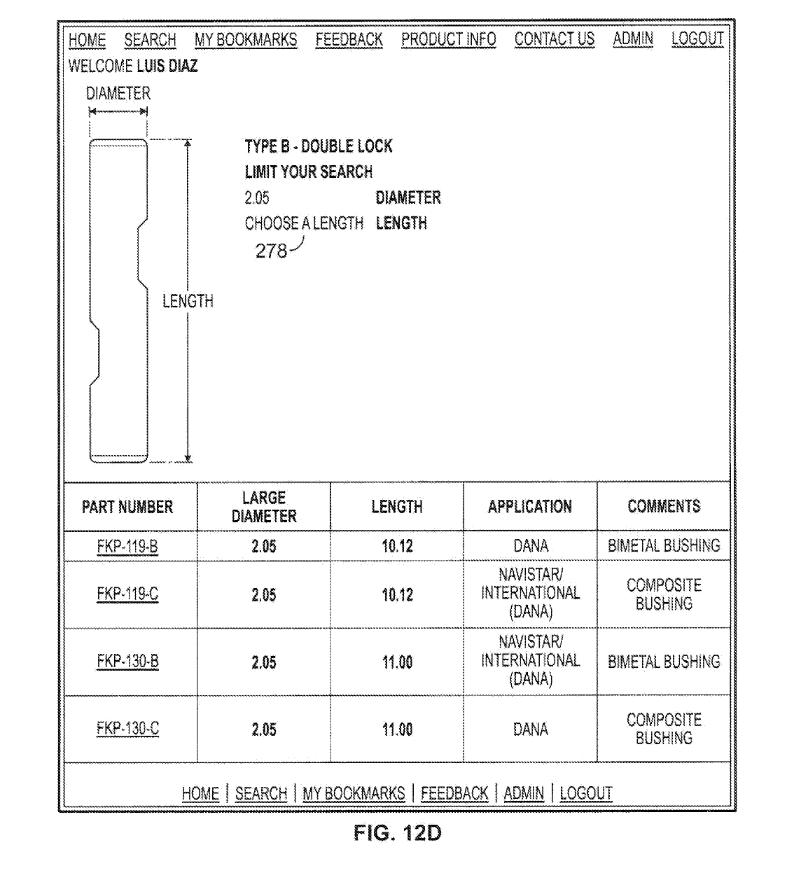

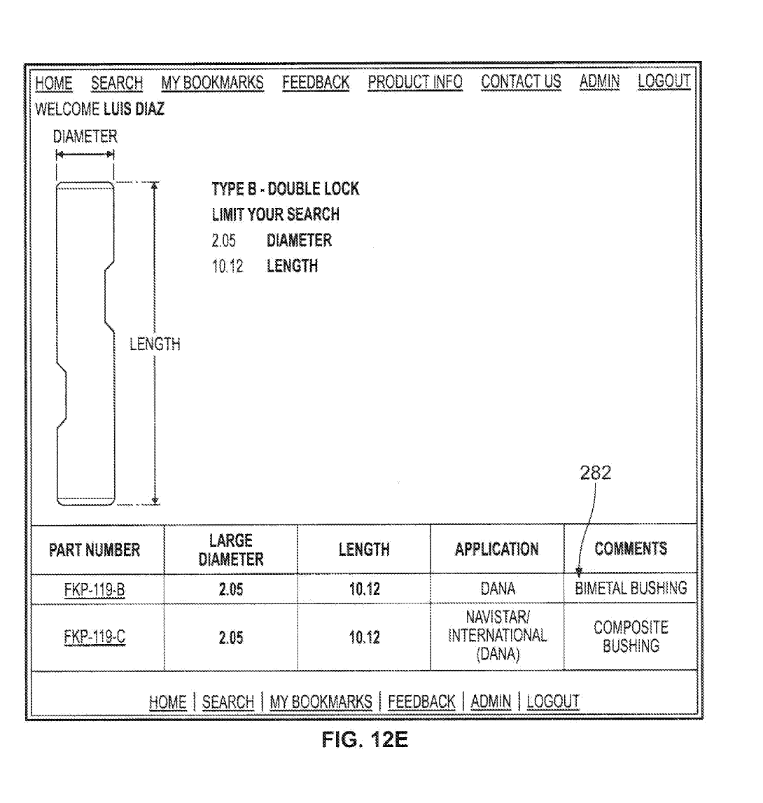

If Steering King Pins (by Dimension) are selected from the initial screen (block 207 in FIG. 9), the screen of FIGS. 12A and 12B is displayed where the user may select between steering king pin types A-F. Once the user selects a king pin type (block 272 in FIG. 9), the screen of FIG. 12C is displayed. The user is prompted to choose a diameter via drop down menu 274 (block 276 in FIG. 9). Once this selection is made, the screen of FIG. 12D is displayed, which prompts the user to choose a length via pull down menu 278 (block 280 in FIG. 9). Once this selection is made, the king pins corresponding to the entered search criteria are identified as indicated at 282 in the screen of FIG. 12E.

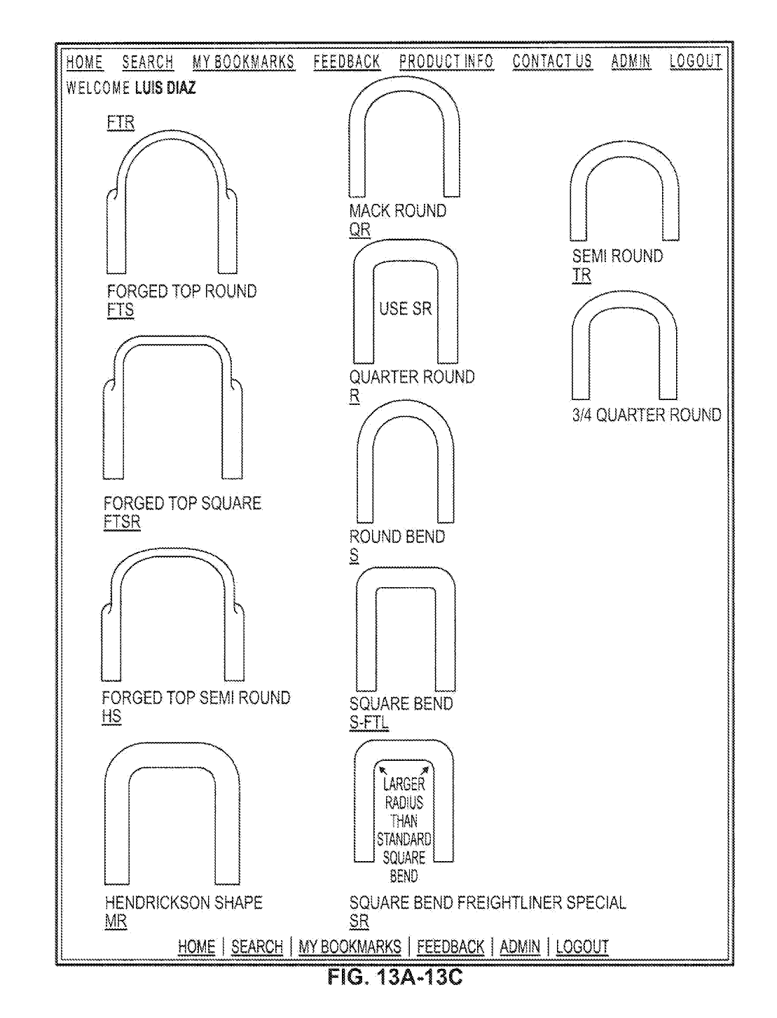

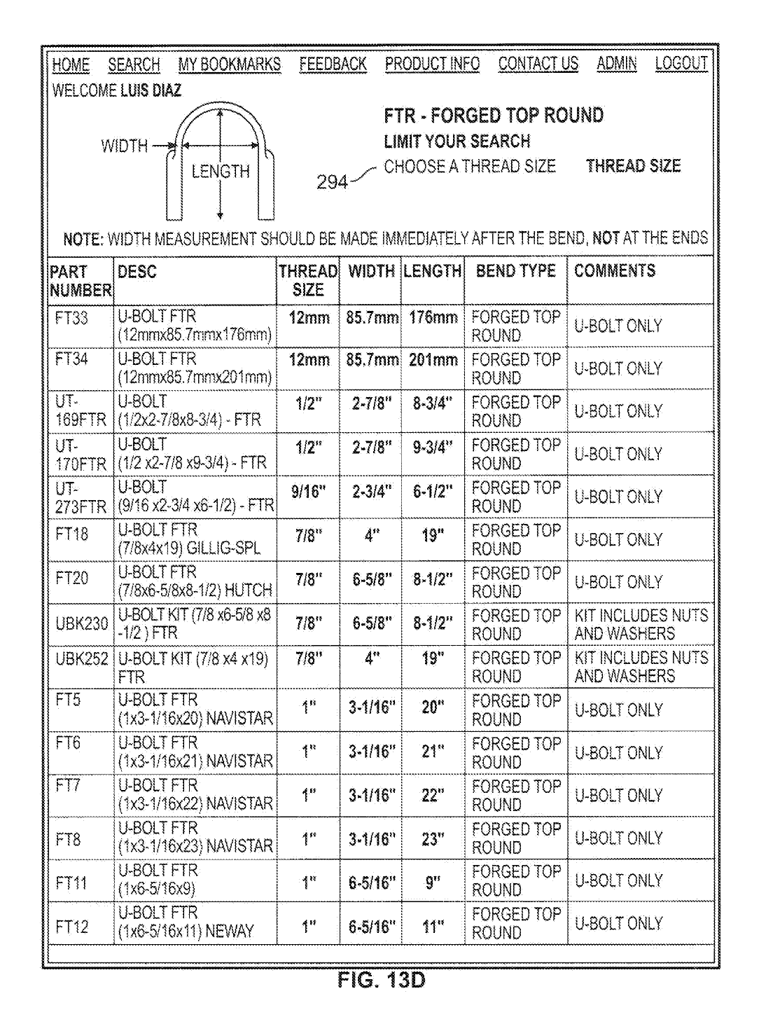

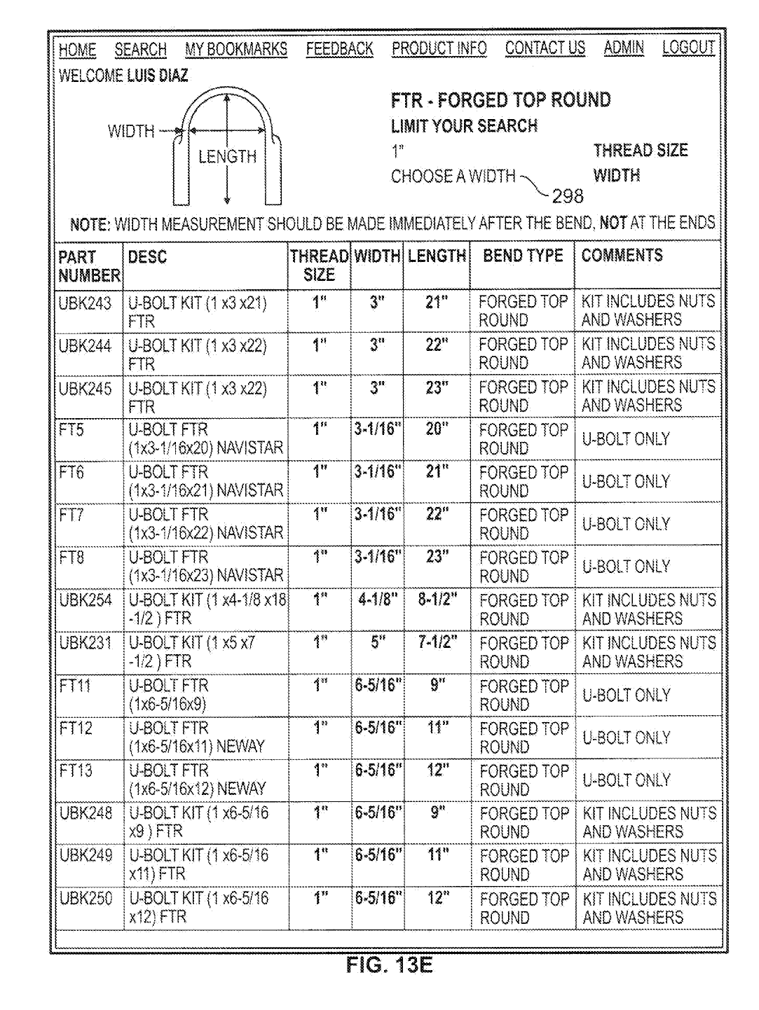

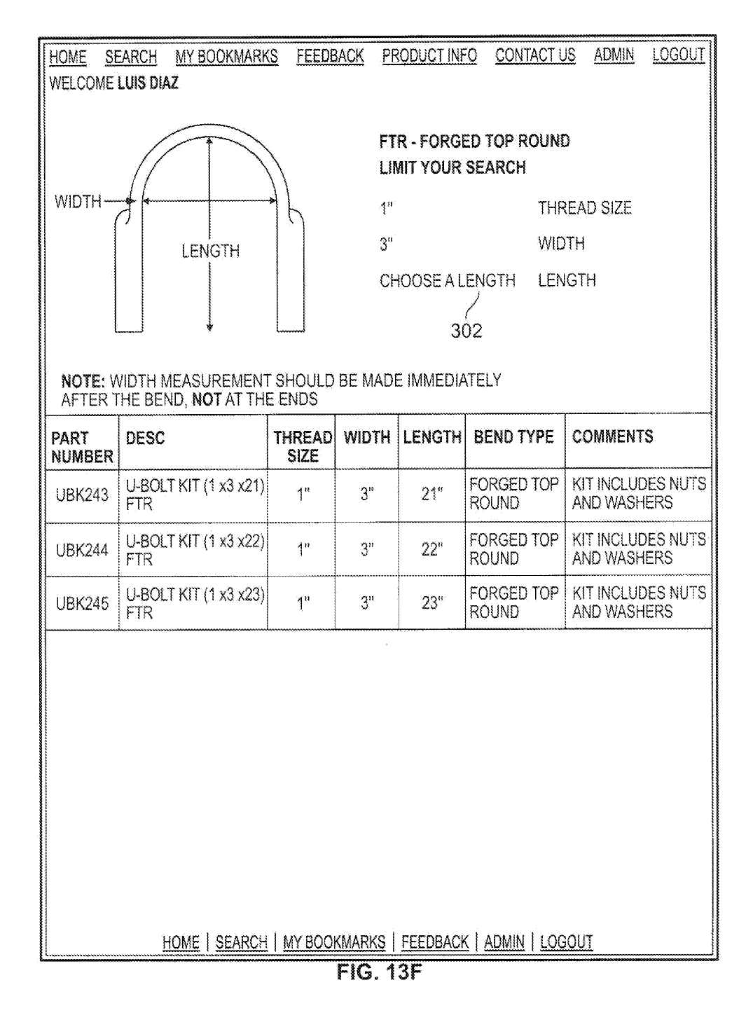

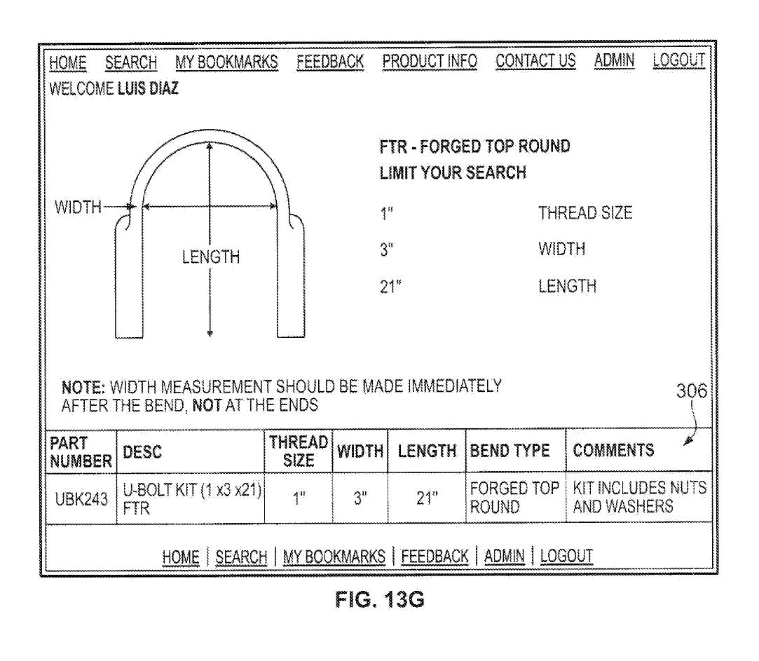

If U-Bolts are selected from the initial screen (block 208 in FIG. 9), the screen of FIGS. 13A-13C are displayed where the user may select between U-bolt types FTR, FTS, FTSR, HS, MR, QR, R, S, S-FTL, SR or TR. Once the user selects a U-bolt type (block 292 in FIG. 9), the screen of FIG. 13D is displayed. When viewing this screen, the user is prompted to choose a thread size via drop down menu 294 (block 296 in FIG. 9). Once this selection is made, the screen of FIG. 13E is displayed, which prompts the user to choose a width, as defined in the U-bolt image, via pull down menu 298 (block 300 in FIG. 9). Once this selection is made, the screen of FIG. 13F is displayed, which prompts the user to choose a length, as defined in the U-bolt image, via pull down menu 302 (block 304 in FIG. 9). Once this selection is made, the screen of FIG. 13G is displayed, upon which the U-bolt corresponding to the entered search criteria is identified at 306.

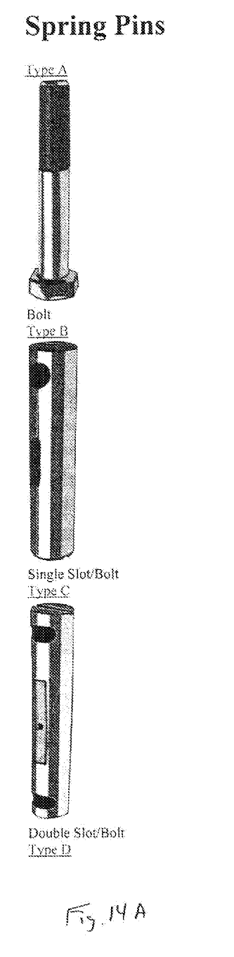

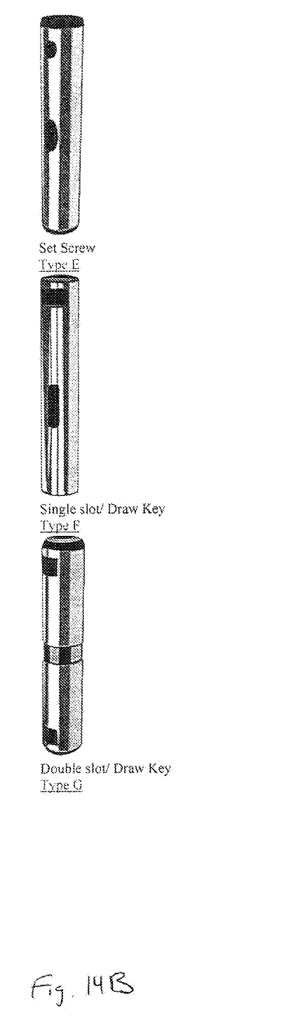

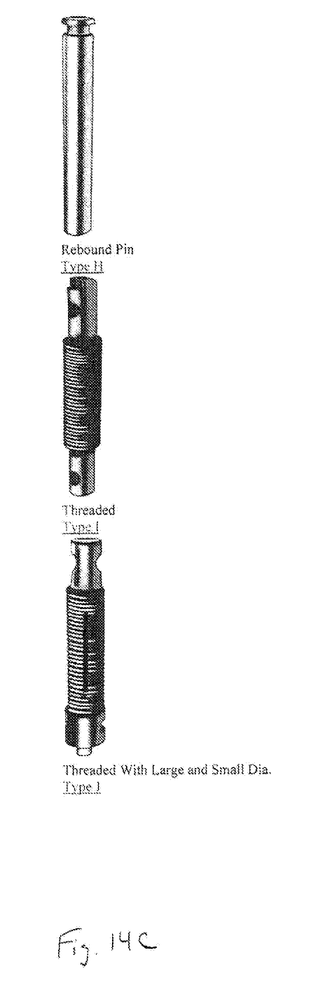

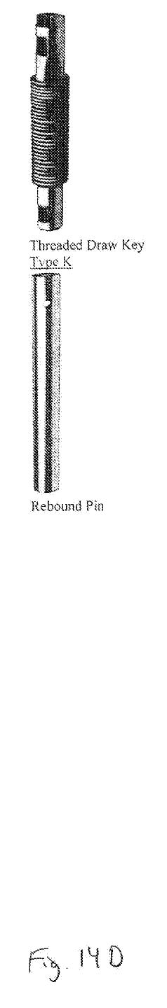

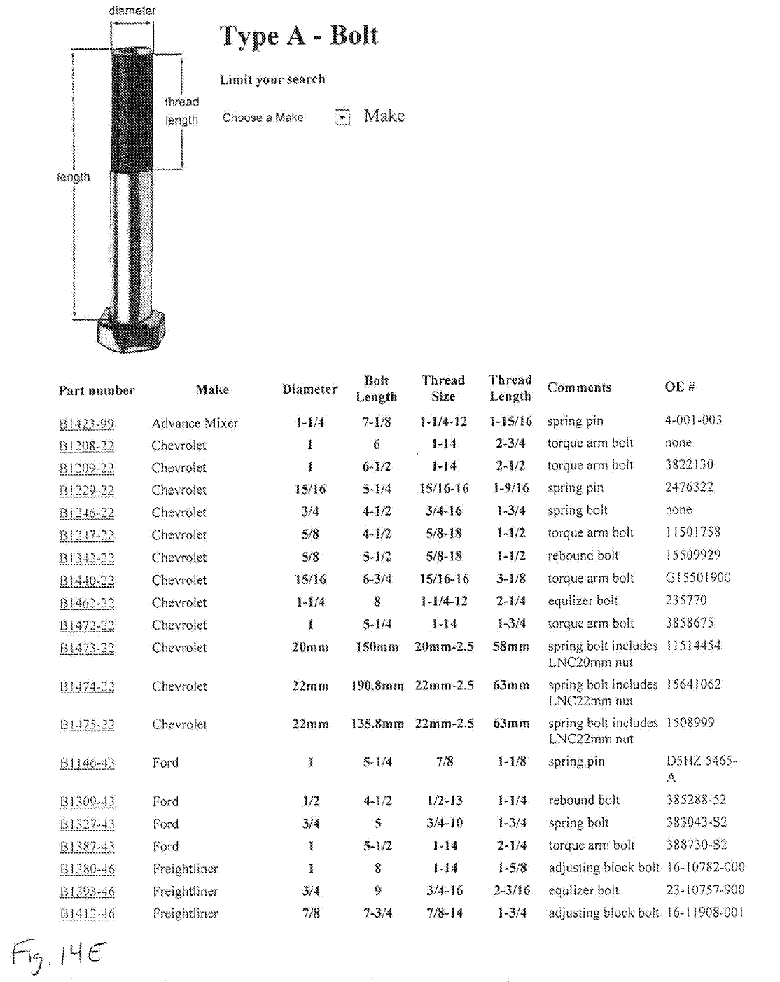

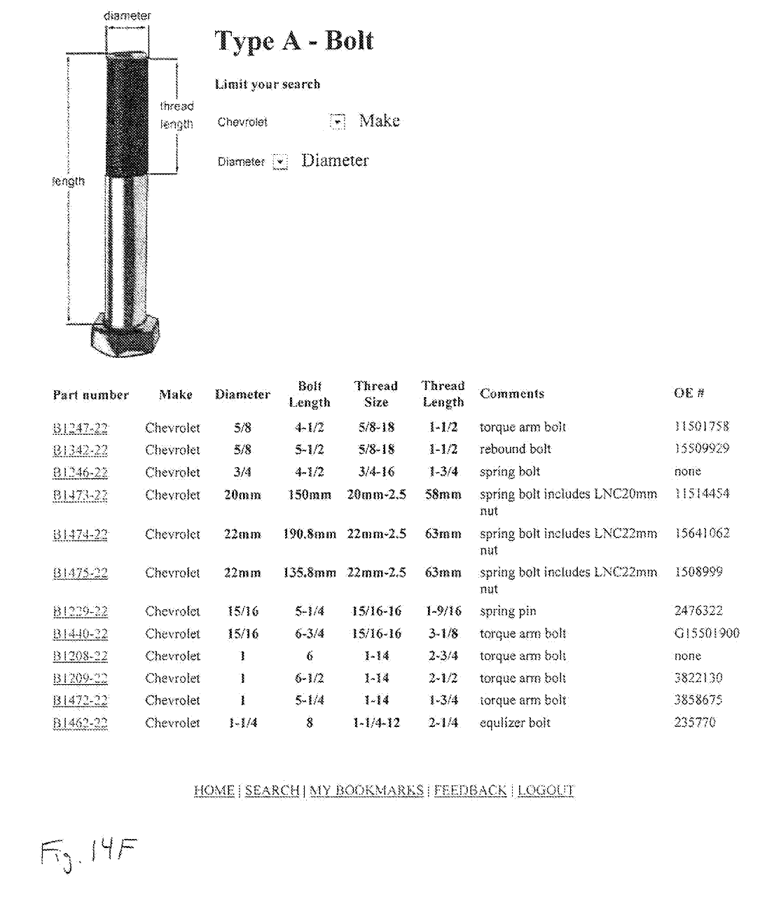

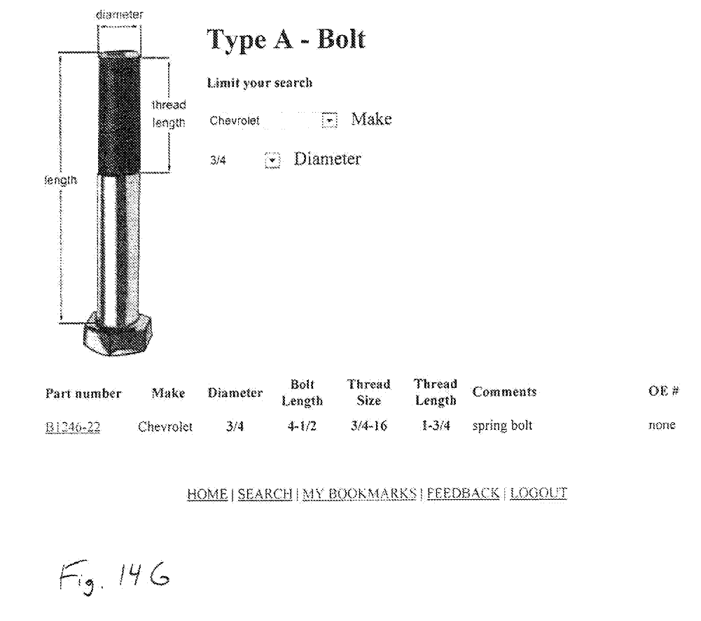

If Spring Pins are selected from the initial screen (block 320 in FIG. 9), the screen of FIGS. 14A-14D are displayed where the user may select between spring pin types A-K. Once the user selects a king pin type (block 326 in FIG. 9), the screen of FIG. 14E is displayed. The user is prompted to choose a make (i.e. manufacturer) via drop down menu 328 (block 330 in FIG. 9). Once this selection is made, the screen of FIG. 14F is displayed, which prompts the user to choose a diameter via pull down menu 332 (block 334 in FIG. 9). Once this selection is made, the spring pins corresponding to the entered search criteria are identified as indicated at 336 in the screen of FIG. 140. Additional information for the spring pin may be accessed by clicking on a link 337.

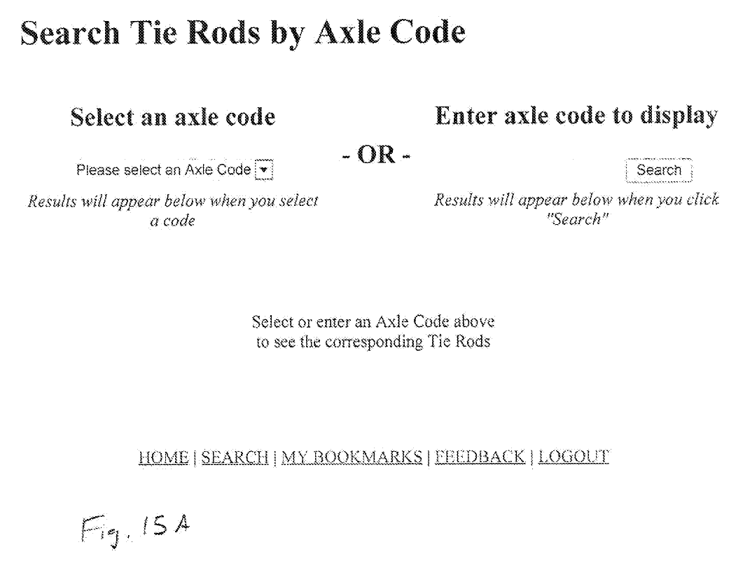

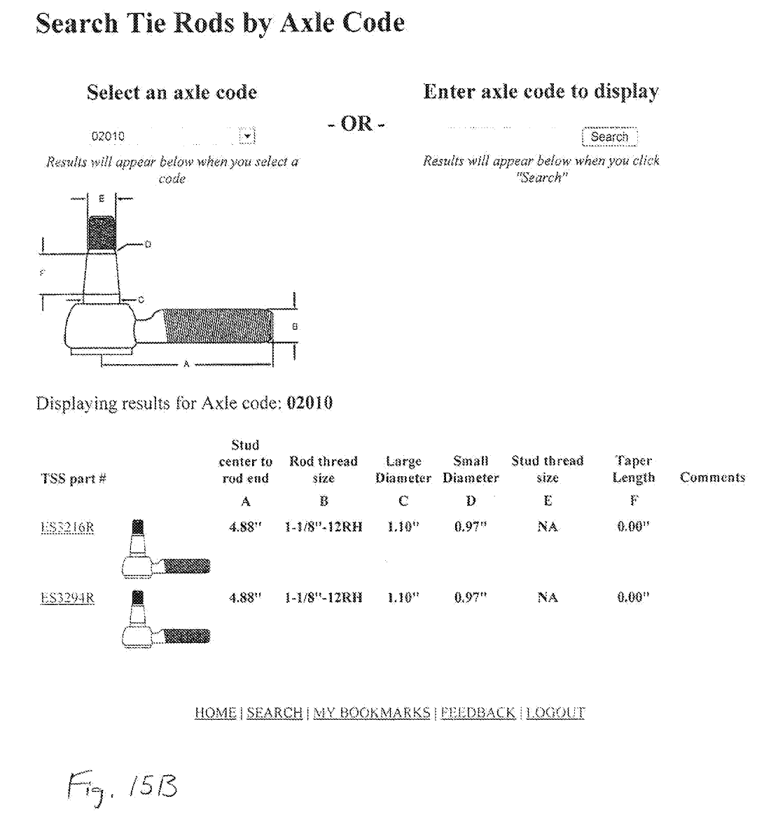

If Tie Rods (by Axle Code) is selected from the initial screen (block 322 in FIG. 9), the screen of FIG. 15A is displayed where the user may select between looking up a tie rod by axle code by selecting an axle code from the pull down menu 340 or by entering an axle code into the search field at 342. Once the user enters an axle code (block 344 in FIG. 9), the screen of FIG. 15B, listing the appropriate tie rods at 344, is displayed. Additional information for a tie rod may be accessed by clicking on a link 345.

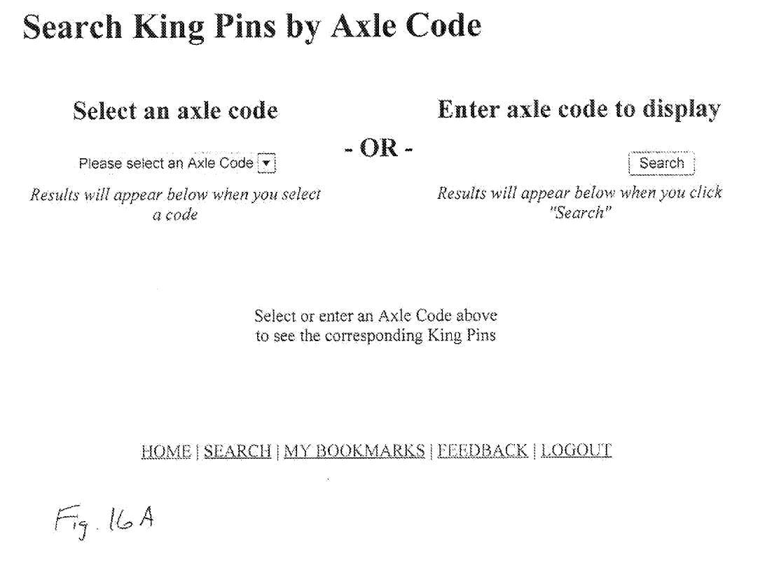

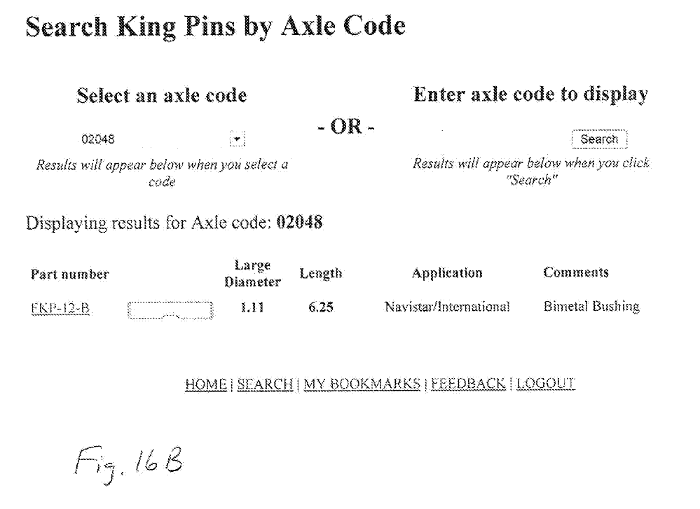

If King Pins (by Axle Code) is selected from the initial screen (block 324 in FIG. 9), the screen of FIG. 16A is displayed where the user may select between looking up a king pin by axle code by selecting an axle code from the pull down menu 346 or by entering an axle code into the search field at 348. Once the user enters an axle code (block 350 in FIG. 9), the screen of FIG. 16B, listing the appropriate king pin at 352, is displayed. Additional information for the king pin may be accessed by clicking on a link 353.

While the preferred embodiments of the invention have been shown and described, it will be apparent to those skilled in the art that changes and modifications may be made therein without departing from the spirit of the invention, the scope of which is defined by the appended claims.

What is claimed is:

1. An electronic catalog system for identifying a component comprising:
a. computer memory storage upon which is stored software and a database containing data for a plurality of types of the component, where the data includes images, diagrams, dimensions and specifications for each of the plurality of types of the component;
b. a workstation;
c. a server computer in communication with the computer memory storage and the workstation, said server computer executing the software so that:
i) images of the plurality of types of the component are displayed on the workstation to a user;
ii) the user may select one of the plurality of types of the component using the workstation;
iii) a plurality of alternative diagrams for the selected type of component are displayed on the workstation;
iv) the user may select one of the plurality of alternative diagrams using the workstation;
v) a dimension is illustrated on the selected diagram on the workstation;
vi) the user may enter the dimension illustrated on the selected diagram using the workstation;
vii) a component matching the selected type, the selected diagram and the entered dimension is displayed on the workstation.

2. The system of claim 1 wherein in c. vii) the server computer executes the software so that a list of components matching the selected type, the selected diagram and the entered dimension is displayed on the workstation, and where the server computer executes the software so that:
viii) specifications for a listed component are displayed on the workstation when the user selects the listed component using the workstation.

3. The system of claim 2 wherein the specifications include a manufacturer and an OEM part number.

4. The system of claim 3 wherein the specifications include cross reference numbers for other manufacturers.

5. The system of claim 1 wherein the component is a vehicle suspension component.

6. The system of claim 1 wherein the component is an air spring.

7. The system of claim 6 wherein the diagram is a top plate layout of the air spring.

8. The system of claim 7 wherein the dimension is the spacing between top plate mounting holes.

9. The system of claim 6 wherein a user may also enter a number of studs for the air spring and the component displayed in vii) matches the selected type, the selected diagram, the entered dimension and the entered number of studs.

10. The system of claim 6 wherein a user may also enter an air inlet size for the air spring and the component displayed in vii) matches the selected type, the selected diagram, the entered dimension and the entered air inlet size.

11. The system of claim 6 wherein a user may also enter a number of bottom plate studs for the air spring and the component displayed in vii) matches the selected type, the selected diagram, the entered dimension and the entered number of bottom plate studs.

12. The system of claim 1 wherein a user may also enter a top plate diameter for the air spring and the component displayed in vii) matches the selected type, the selected diagram, the entered dimension and the entered top plate diameter.

13. The system of claim 1 wherein the component is a first component and the user may also search for a second special component in addition to the first component.

14. The system of claim 13 wherein the first component is an air spring and the special component is a different suspension component.

15. A machine-readable medium on which has been prerecorded a computer program which, when executed by a processor, performs the following steps:
a. displays images of the plurality of types of the component to a user;
b. receives a selection of one of the plurality of types of the components from the user;
c. displays a plurality of alternative diagrams for the selected type of component;
d. receives a selection of one of the plurality of alternative diagrams from the user;
e. illustrates a dimension on the selected diagram;
f. receives a user entry for the dimension illustrated on the selected diagram;
g. displays a component matching the selected type, the selected diagram and the entered dimension.

16. The machine-readable medium of claim 15 wherein step g. includes displaying a listing of components that match the selected type, the selected diagram and the entered dimension, and further performs the step of:
h. displaying specifications for a listed component on the workstation in response to a user selecting the listed component.

17. The machine-readable medium of claim 16 wherein the component is an air spring.

18. A method for identifying a component comprising the steps of:
a. providing computer memory storage upon which is stored software and a database containing data for a plurality of types of the component, where the data includes images, diagrams, dimensions and specifications for each of the plurality of types of the component, a workstation and a server computer in communication with the computer memory storage and the workstation;
b. displaying images of the plurality of types of the component on the workstation to a user;
c. receiving from the workstation one of the plurality of types of the component selected by the user;
d. displaying a plurality of alternative diagrams for the selected type of component on the workstation;
e. receiving from the workstation one of the plurality of alternative diagrams selected by the user;
f. illustrating a dimension on the selected diagram on the workstation;
g. receiving from the workstation a user entry for the dimension illustrated on the selected diagram;
h. displaying a component matching the selected type, the selected diagram and the entered dimension on the workstation.

19. The method of claim 18 wherein step h. includes listing components that match the selected type, the selected diagram and the entered dimension, and further comprising the step of:
i. displaying specifications for a listed component on the workstation in response to a user selecting the listed component.

20. The system of claim 18 wherein the component is an air spring.
